(19) United States
(12) Patent Application Publication
(10) Pub. No.: US 2019/0041950 A1
(43) Pub. Date: Feb. 7, 2019

(54) System, Apparatus And Method For Data Driven Low Power State Control Based On Performance Monitoring Information

(71) Applicant: Intel Corporation, Santa Clara, CA (US)

(72) Inventors: Michael W. Chynoweth, Placitas, NM (US); Rajshree Chabukswar, Sunnyvale, CA (US); Eliezer Weissmann, Haifa (IL); Jason W. Brandt, Austin, TX (US); Alexander Gendler, Kiriat Motzkin (IL); Ahmad Yasin, Haifa (IL); Patrick Konsor, Hillsboro, OR (US); Sneha Gohad, San Jose, CA (US); William Freelove, Hillsboro, OR (US)

(21) Appl. No.: 15/938,268

(22) Filed: Mar. 28, 2018

(51) Int. Cl. G06F 1/32; G06F 12/1045; G06F 11/34

(52) U.S. Cl. CPC G06F 1/3206; G06F 1/3246; G06F 2212/68; G06F 12/1045; G06F 11/3409; G06F 1/3296

(57) ABSTRACT

In one embodiment, a processor includes one or more cores including a cache memory hierarchy; a performance monitor coupled to the one or more cores, the performance monitor to monitor performance of the one or more cores, the performance monitor to calculate pipeline cost metadata based at least in part on count information associated with the cache memory hierarchy; and a power controller coupled to the performance monitor, the power controller to receive the pipeline cost metadata and determine a low power state for the one or more cores to enter based at least in part on the pipeline cost metadata. Other embodiments are described and claimed.

### TECHNICAL FIELD

Embodiments relate to power management of a system, and more particularly to power management of a multicore processor.

### BACKGROUND

Advances in semiconductor processing and logic design have permitted an increase in the amount of logic that may be present on integrated circuit devices. As a result, computer system configurations have evolved from a single or multiple integrated circuits in a system to multiple hardware threads, multiple cores, multiple devices, and/or complete systems on individual integrated circuits. Additionally, as the density of integrated circuits has grown, the power requirements for computing systems (from embedded systems to servers) have also escalated. Furthermore, software inefficiencies, and its requirements of hardware, have also caused an increase in computing device energy consumption. In fact, some studies indicate that computing devices consume a sizeable percentage of the entire electricity supply for a country, such as the United States of America. As a result, there is a vital need for energy efficiency and conservation associated with integrated circuits. These needs will increase as servers, desktop computers, notebooks, Ultrabooks™, tablets, mobile phones, processors, embedded systems, etc. become even more prevalent (from inclusion in the typical computer, automobiles, and televisions to biotechnology).

One manner of reducing power consumption in a processor is to allow one or more cores to enter into low power states when they are not busy. However, incorrect decisions as to appropriate placement of cores into low power states (and the particular low power states themselves) may risk performance, responsiveness, user experience and/or quality of service issues. Such concerns are particularly manifest when software requests a particular low power state without visibility into actual processor operation and low power state impact on operation.

### BRIEF DESCRIPTION OF THE DRAWINGS

FIG. 1 is a block diagram of a portion of a system in accordance with an embodiment of the present invention.

FIG. 2 is a block diagram of a processor in accordance with an embodiment of the present invention.

FIG. 3 is a block diagram of a multi-domain processor in accordance with another embodiment of the present invention.

FIG. 4 is an embodiment of a processor including multiple cores.

FIG. 5 is a block diagram of a micro-architecture of a processor core in accordance with one embodiment of the present invention.

FIG. 6 is a block diagram of a micro-architecture of a processor core in accordance with another embodiment.

FIG. 7 is a block diagram of a micro-architecture of a processor core in accordance with yet another embodiment.

FIG. 8 is a block diagram of a micro-architecture of a processor core in accordance with a still further embodiment.

FIG. 9 is a block diagram of a processor in accordance with another embodiment of the present invention.

FIG. 10 is a block diagram of a representative SoC in accordance with an embodiment of the present invention.

FIG. 11 is a block diagram of another example SoC in accordance with an embodiment of the present invention.

FIG. 12 is a block diagram of an example system with which embodiments can be used.

FIG. 13 is a block diagram of another example system with which embodiments may be used.

FIG. 14 is a block diagram of a representative computer system.

FIG. 15 is a block diagram of a system in accordance with an embodiment of the present invention.

FIG. 16 is a block diagram illustrating an IP core development system used to manufacture an integrated circuit to perform operations according to an embodiment.

FIG. 17 is a flow diagram of a method in accordance with an embodiment of the present invention.

FIG. 18 is a flow diagram of another method in accordance with an embodiment of the present invention.

FIG. 19 is a flow diagram of a method in accordance with yet another embodiment of the present invention.

### DETAILED DESCRIPTION

In various embodiments, information available within a processor, such as may be collected and analyzed in a performance monitoring unit of the processor, may be used to make data-driven decisions as to appropriate low power states for the processor. More specifically as described herein, performance monitoring information can be provided from a performance monitor to a power controller of the processor to enable the power controller to make better, data driven, decisions as to appropriate low power states for one or more cores and/or other processing engines of the processor to enter.

In typical systems, software and processor hardware interact to determine when to enter a low power state (such as an inactive state according to Advanced Configuration and Power Interface (ACPI) standard, enumerated as a given non-C0 state, referred to also as a sleep or C-state), and what level of core/package C-state can be achieved without risking undesired performance, responsiveness, user experience or quality of service (QoS) impact. Without an embodiment, however, a software entity such as an operating system (OS) or driver may provide mistaken hints that can cause degradations in performance when sleep states are enabled, when processor hardware does not detect these mistaken hints.

In embodiments, a processor power controller may take into account particular performance monitoring information received from the performance monitor to determine an appropriate low power state for a core/processor, which may be a different low power state than that requested by a software entity. The degradation in performance without an embodiment may be due to the latency of exiting the sleep state and the cost of refilling flushed architecture states during the last sleep state (e.g., one or more of data translation lookaside buffer (DTLB), instruction TLB (ITLB), level 1 (L1) instruction cache, L1 data cache and level 2 (L2) cache).

In addition to performance monitoring information regarding cache memory operation, embodiments may further use performance monitoring information regarding interrupt activity of the processor. This is so, as there can be certain circumstances that can risk QoS if a deep sleep state is achieved. Such circumstances may include instances of higher interrupt rate activity, where delays in responding to an interrupt could cause issues in QoS, or when the currently executed code is highly dependent for performance on one of the caches being flushed.

Using performance monitoring information as described herein, embodiments may determine when entering deeper sleep states may cost performance, including the increased costs of missing in one or more cache memories as well as when QoS might be compromised during a high rate of interrupts. More specifically, embodiments leverage indicative performance monitoring statistics to determine the cost of, e.g., various cache flushes. In this way, a power controller may make more intelligent decisions as to which architectural components can safely be flushed for performance. In particular embodiments herein, the power controller can compare the cost of the cache flushes when various C-states were previously achieved (and exited). The power controller may further leverage interrupt information from the performance monitor to identify additional situations that are not conducive to deeper sleep states, such as in the presence of high interrupt rates.

Note that ultimate decisions by the power controller as to appropriate low power state operation utilizing data from the performance monitor may be transparent to software. Stated another way, the power controller is configured to override OS/driver requests (without reporting back to the software) by making C-state demotion and promotion decisions. A demotion operation occurs when a software entity makes a request for a given low power state and the power controller causes entry into a shallower low power state. And a promotion operation occurs when a software entity makes a request for a given low power state and the power controller causes entry into a deeper low power state.

By leveraging information from a performance monitor as described herein, embodiments may make better decisions surrounding sleep states. Thus based at least in part on this information, a power controller may determine whether and when to be more or less aggressive (as compared to software requests) with regard to low power state operation. Embodiments further provide a dynamic framework to enable turning off all or a portion of a processor based on run-time heuristics, realizing more user experience-friendly decisions.

In some embodiments, the performance monitoring information may be in the form of pipeline cost metadata. As an example, the performance monitor may send ratio information that includes dynamic estimations as to the cost of flushing various architectural states when deeper and lesser C-states are achieved. Example costs may include information as to the cost of missing in a variety of cache memory structures including ITLB/DTLB/L1I/L1D/L2, when lesser and deeper sleep states are achieved. With this information, the power controller can dynamically make better data driven decisions on when to allow demotions and promotions and choose the appropriate C-state for best performance/power efficiency. The performance monitoring information may further include interrupt rate metadata to enable the power controller to detect conditions such as high interrupt rates on any core that could produce conditions that might hurt performance, responsiveness or QoS if a deeper sleep state was attempted.

Referring now to Table 1, shown is an example of pipeline cost metadata for various cache memories for multiple low power states. Such ratios/values may be sent to a power controller to make appropriate low power state decisions to achieve an appropriate power/responsiveness balance. Specifically, Table 1 shows the difference in miss rates (in terms of cycles) following a shallower low power state (e.g., C1) (with deeper low power states disabled) and a deeper low power state (e.g., C6). Such information may represent a large number of sleep/wake cycles. More specifically, the second column provides information when a variety of sleep states including C1E-C10 are available, and the third column provides information when only C1 state is available.

As illustrated, a large amount (e.g., approximately 50%) of the increase in C0 cycles following C6 state is as a result of flush of DTLB architectural state prior to the deeper sleep state. As such, comparison of the cost of DTLB misses when the core achieved deeper sleep states vs. C1 sleep state may be used at least in part to control low power state determinations. With information such as shown in Table 1, the power controller may demote an incoming C6 low power state request to a lower C1 low power state activation, avoiding the performance degradation.

TABLE 1

| | C-states | C-states | % of C0 Cycles |
|---|---|---|---|
| Event Names | Enabled | Disabled | Difference |
| CPU_CLK_UNHALTED.THREAD | 7.59E+10 | 6.88E+10 | |
| DTLB_LOAD_MISSES.STLB_HIT | 4.94E+08 | 6.26E+08 | 13.01% |
| DTLB_LOAD_MISSES.WALK_ACTIVE | 6.93E+09 | 4.54E+09 | 33.66% |
| DTLB_STORE_MISSES.STLB_HIT | 9.18E+07 | 1.21E+08 | 2.88% |
| DTLB_STORE_MISSES.WALK_ACTIVE | 9.57E+08 | 6.26E+08 | 4.66% |
| | | TOTAL | 54.22% |

Although the following embodiments are described with reference to specific integrated circuits, such as in computing platforms or processors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to any particular type of computer systems. That is, disclosed embodiments can be used in many different system types, ranging from server computers (e.g., tower, rack, blade, micro-server and so forth), communications systems, storage systems, desktop computers of any configuration, laptop, notebook, and tablet computers (including 2:1 tablets, phablets and so forth), and may be also used in other devices, such as handheld devices, systems on chip (SoCs), and embedded applications. Some examples of handheld devices include cellular phones such as smartphones, Internet protocol devices, digital cameras, personal digital assistants (PDAs), and handheld PCs. Embedded applications may typically include a microcontroller, a digital signal processor (DSP), network computers (NetPC), set-top boxes, network hubs, wide area network (WAN) switches, wearable devices, or any other system that can perform the functions and operations taught below. More so, embodiments may be implemented in mobile terminals having standard voice functionality such as mobile phones, smartphones and phablets, and/or in non-mobile terminals without a standard wireless voice function communication capability, such as many wearables, tablets, notebooks, desktops, micro-servers, servers and so forth. Moreover, the apparatuses, methods, and systems described herein are not limited to physical computing devices, but may also relate to software optimizations.

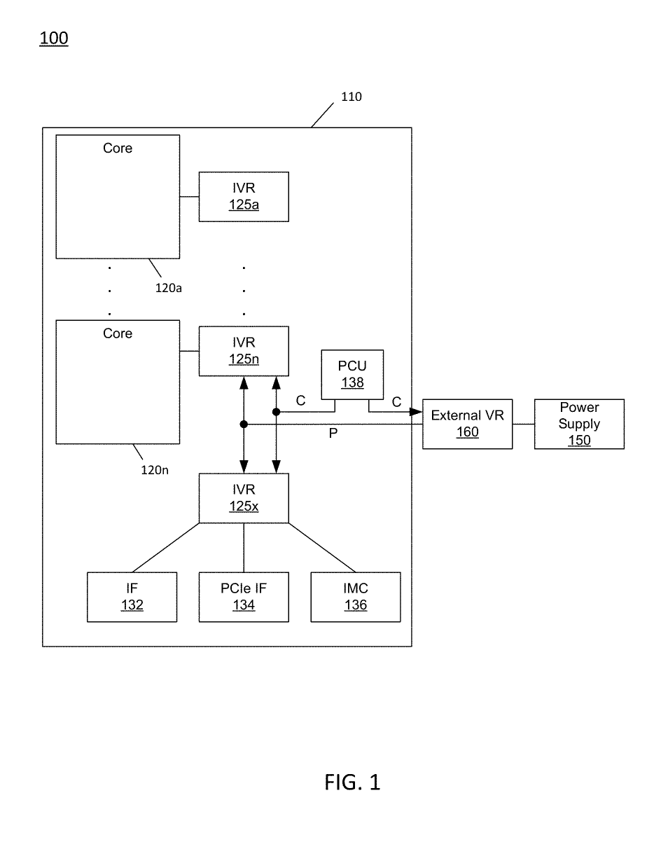

Referring now to FIG. 1, shown is a block diagram of a portion of a system in accordance with an embodiment of the present invention. As shown in FIG. 1, system 100 may include various components, including a processor 110 which as shown is a multicore processor. Processor 110 may be coupled to a power supply 150 via an external voltage regulator 160, which may perform a first voltage conversion to provide a primary regulated voltage to processor 110.

As seen, processor 110 may be a single die processor including multiple cores 120ₐ-120ₙ. In addition, each core may be associated with an integrated voltage regulator (IVR) 125ₐ-125ₙ which receives the primary regulated voltage and generates an operating voltage to be provided to one or more agents of the processor associated with the IVR. Accordingly, an IVR implementation may be provided to allow for fine-grained control of voltage and thus power and performance of each individual core. As such, each core can operate at an independent voltage and frequency, enabling great flexibility and affording wide opportunities for balancing power consumption with performance. In some embodiments, the use of multiple IVRs enables the grouping of components into separate power planes, such that power is regulated and supplied by the IVR to only those components in the group. During power management, a given power plane of one IVR may be powered down or off when the processor is placed into a certain low power state, while another power plane of another IVR remains active, or fully powered.

Still referring to FIG. 1, additional components may be present within the processor including an input/output interface 132, another interface 134, and an integrated memory controller 136. As seen, each of these components may be powered by another integrated voltage regulator 125ₓ. In one embodiment, interface 132 may be enable operation for an Intel® Quick Path Interconnect (QPI) interconnect, which provides for point-to-point (PtP) links in a cache coherent protocol that includes multiple layers including a physical layer, a link layer and a protocol layer. In turn, interface 134 may communicate via a Peripheral Component Interconnect Express (PCIe™) protocol.

Also shown is a power control unit (PCU) 138, which may include hardware, software and/or firmware to perform power management operations with regard to processor 110. As seen, PCU 138 provides control information to external voltage regulator 160 via a digital interface to cause the voltage regulator to generate the appropriate regulated voltage. PCU 138 also provides control information to IVRs 125 via another digital interface to control the operating voltage generated (or to cause a corresponding IVR to be disabled in a low power mode). In various embodiments, PCU 138 may include a variety of power management logic units to perform hardware-based power management. Such power management may be wholly processor controlled (e.g., by various processor hardware, and which may be triggered by workload and/or power, thermal or other processor constraints) and/or the power management may be performed responsive to external sources (such as a platform or management power management source or system software).

In embodiments herein, PCU 138 may be configured to receive performance monitoring information, e.g., from an internal performance monitor of processor 110. Based at least in part on this performance monitoring information, the impact of various low power states may be considered and used to determine appropriate low power state entry for one or more portions of processor 110. In particular embodiments described herein, this data driven control of low power state selection may enable incoming low power state requests, e.g., from a scheduling entity, to be overridden. As such, when it is determined that impact of a deeper low power state is relatively high, an incoming request for such deeper low power state may be demoted to cause processor 110 (or a portion thereof) to enter into a shallower low power state. In turn, when there is relatively low impact as a result of deeper low power states, an incoming request for a shallower low power state may be promoted to a deeper low power state, as described further herein.

While not shown for ease of illustration, understand that additional components may be present within processor 110 such as uncore logic, and other components such as internal memories, e.g., one or more levels of a cache memory hierarchy and so forth. Furthermore, while shown in the implementation of FIG. 1 with an integrated voltage regulator, embodiments are not so limited.

Processors described herein may leverage power management techniques that may be independent of and complementary to an operating system (OS)-based power management (OSPM) mechanism. According to one example OSPM technique, a processor can operate at various performance states or levels, so-called P-states, namely from P0 to PN. In general, the P1 performance state may correspond to the highest guaranteed performance state that can be requested by an OS. In addition to this P1 state, the OS can further request a higher performance state, namely a P0 state. This P0 state may thus be an opportunistic or turbo mode state in which, when power and/or thermal budget is available, processor hardware can configure the processor or at least portions thereof to operate at a higher than guaranteed frequency. In many implementations a processor can include multiple so-called bin frequencies above the P1 guaranteed maximum frequency, exceeding to a maximum peak frequency of the particular processor, as fused or otherwise written into the processor during manufacture. In addition, according to one OSPM mechanism, a processor can operate at various power states or levels. With regard to power states, an OSPM mechanism may specify different power consumption states, generally referred to as C-states, C0, C1 to Cn states. When a core is active, it runs at a C0 state, and when the core is idle it may be placed in a core low power state, also called a core non-zero C-state (e.g., C1-C6 states), with each C-state being at a lower power consumption level (such that C6 is a deeper low power state than C1, and so forth).

Understand that many different types of power management techniques may be used individually or in combination in different embodiments. As representative examples, a power controller may control the processor to be power managed by some form of dynamic voltage frequency scaling (DVFS) in which an operating voltage and/or operating frequency of one or more cores or other processor logic may be dynamically controlled to reduce power consumption in certain situations. In an example, DVFS may be performed using Enhanced Intel SpeedStep™ technology available from Intel Corporation, Santa Clara, Calif., to provide optimal performance at a lowest power consumption level. In another example, DVFS may be performed using Intel TurboBoost™ technology to enable one or more cores or other compute engines to operate at a higher than guaranteed operating frequency based on conditions (e.g., workload and availability).

Another power management technique that may be used in certain examples is dynamic swapping of workloads between different compute engines. For example, the processor may include asymmetric cores or other processing engines that operate at different power consumption levels, such that in a power constrained situation, one or more workloads can be dynamically switched to execute on a lower power core or other compute engine. Another exemplary power management technique is hardware duty cycling (HDC), which may cause cores and/or other compute engines to be periodically enabled and disabled according to a duty cycle, such that one or more cores may be made inactive during an inactive period of the duty cycle and made active during an active period of the duty cycle.

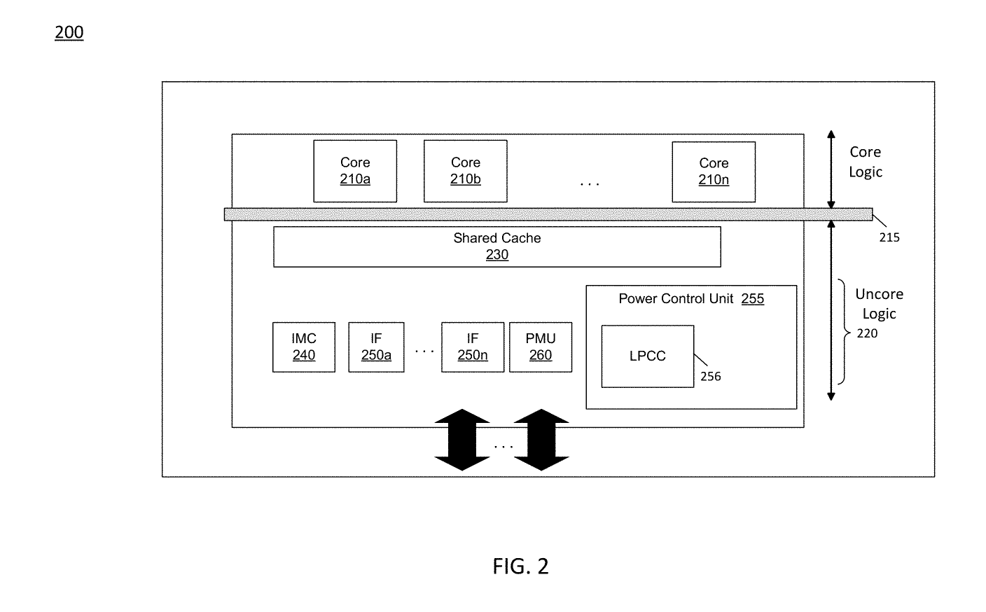

Embodiments can be implemented in processors for various markets including server processors, desktop processors, mobile processors and so forth. Referring now to FIG. 2, shown is a block diagram of a processor in accordance with an embodiment of the present invention. As shown in FIG. 2, processor 200 may be a multicore processor including a plurality of cores 210ₐ-210ₙ. In one embodiment, each such core may be of an independent power domain and can be configured to enter and exit active states and/or maximum performance states based on workload.

The various cores may be coupled via an interconnect 215 to a system agent or uncore 220 that includes various components. As seen, the uncore 220 may include a shared cache 230 which may be a last level cache. In addition, the uncore may include an integrated memory controller 240 to communicate with a system memory (not shown in FIG. 2), e.g., via a memory bus. Uncore 220 also includes various interfaces 250, a performance monitoring unit (PMU) 260 and a power control unit 255, which may include logic to perform power management techniques as described herein. In addition, power control unit 255 may include a low power control circuit 256, configured to receive performance monitoring information from PMU 260 and based at least in part on this information determine an appropriate low power state for processor 200 to enter (which may be a demoted or promoted state, based upon the performance monitoring information).

In addition, by interfaces 250ₐ-250ₙ, connection can be made to various off-chip components such as peripheral devices, mass storage and so forth. While shown with this particular implementation in the embodiment of FIG. 2, the scope of the present invention is not limited in this regard.

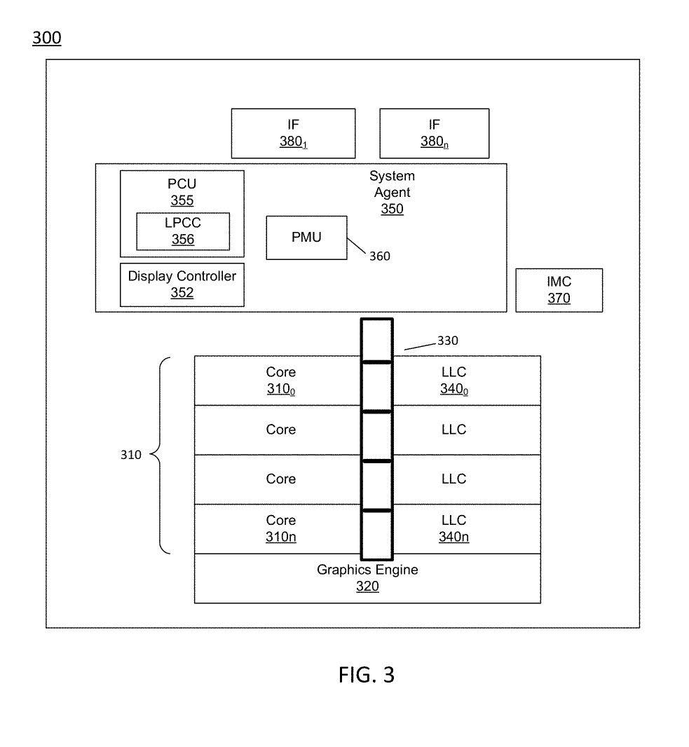

Referring now to FIG. 3, shown is a block diagram of a multi-domain processor in accordance with another embodiment of the present invention. As shown in the embodiment of FIG. 3, processor 300 includes multiple domains. Specifically, a core domain 310 can include a plurality of cores 310₀-310ₙ, a graphics domain 320 can include one or more graphics engines, and a system agent domain 350 may further be present. In some embodiments, system agent domain 350 may execute at an independent frequency than the core domain and may remain powered on at all times to handle power control events and power management such that domains 310 and 320 can be controlled to dynamically enter into and exit high power and low power states. Each of domains 310 and 320 may operate at different voltage and/or power. Note that while only shown with three domains, understand the scope of the present invention is not limited in this regard and additional domains can be present in other embodiments. For example, multiple core domains may be present each including at least one core.

In general, each core 310 may further include low level caches in addition to various execution units and additional processing elements. In turn, the various cores may be coupled to each other and to a shared cache memory formed of a plurality of units of a last level cache (LLC) 340₀-340ₙ. In various embodiments, LLC 340 may be shared amongst the cores and the graphics engine, as well as various media processing circuitry. As seen, a ring interconnect 330 thus couples the cores together, and provides interconnection between the cores, graphics domain 320 and system agent circuitry 350. In one embodiment, interconnect 330 can be part of the core domain. However in other embodiments the ring interconnect can be of its own domain.

As further seen, system agent domain 350 may include display controller 352 which may provide control of and an interface to an associated display. As further seen, system agent domain 350 may include a PMU 360 and a power control unit 355, which can include a low power control circuit 356 which, based at least in part on performance monitoring information, is to determine a cost to various processor resources as a result of prior iterations of certain low power states (e.g., C1 and C6 low power states). Based at least in part on this information, low power control circuit 356 may determine an appropriate low power state for processor 300 (or at least a portion thereof) to enter, which may be a demoted or promoted state with respect to a requested low power state (e.g., by way of hint information received from an operating system or other scheduling entity), as described herein.

As further seen in FIG. 3, processor 300 can further include an integrated memory controller (IMC) 370 that can provide for an interface to a system memory, such as a dynamic random access memory (DRAM). Multiple interfaces 380₀-380ₙ may be present to enable interconnection between the processor and other circuitry. For example, in one embodiment at least one direct media interface (DMI) interface may be provided as well as one or more PCIe™ interfaces. Still further, to provide for communications between other agents such as additional processors or other circuitry, one or more QPI interfaces may also be provided. Although shown at this high level in the embodiment of FIG. 3, understand the scope of the present invention is not limited in this regard.

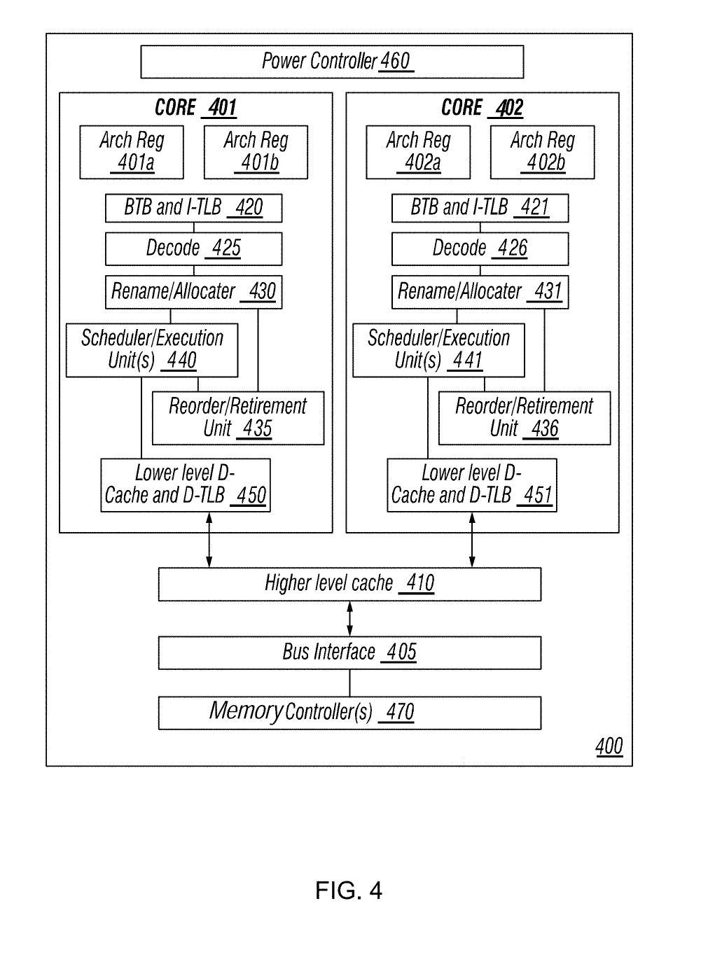

Referring to FIG. 4, an embodiment of a processor including multiple cores is illustrated. Processor 400 includes any processor or processing device, such as a microprocessor, an embedded processor, a digital signal processor (DSP), a network processor, a handheld processor, an application processor, a co-processor, a system on a chip (SoC), or other device to execute code. Processor 400, in one embodiment, includes at least two cores—cores 401 and 402, which may include asymmetric cores or symmetric cores (the illustrated embodiment). However, processor 400 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 400, as illustrated in FIG. 4, includes two cores, cores 401 and 402. Here, cores 401 and 402 are considered symmetric cores, i.e., cores with the same configurations, functional units, and/or logic. In another embodiment, core 401 includes an out-of-order processor core, while core 402 includes an in-order processor core. However, cores 401 and 402 may be individually selected from any type of core, such as a native core, a software managed core, a core adapted to execute a native instruction set architecture (ISA), a core adapted to execute a translated ISA, a co-designed core, or other known core. Yet to further the discussion, the functional units illustrated in core 401 are described in further detail below, as the units in core 402 operate in a similar manner.

As depicted, core 401 includes two hardware threads 401a and 401b, which may also be referred to as hardware thread slots 401a and 401b. Therefore, software entities, such as an operating system, in one embodiment potentially view processor 400 as four separate processors, i.e., four logical processors or processing elements capable of executing four software threads concurrently. As alluded to above, a first thread is associated with architecture state registers 401a, a second thread is associated with architecture state registers 401b, a third thread may be associated with architecture state registers 402a, and a fourth thread may be associated with architecture state registers 402b. Here, each of the architecture state registers (401a, 401b, 402a, and 402b) may be referred to as processing elements, thread slots, or thread units, as described above. As illustrated, architecture state registers 401a are replicated in architecture state registers 401b, so individual architecture states/contexts are capable of being stored for logical processor 401a and logical processor 401b. In core 401, other smaller resources, such as instruction pointers and renaming logic in allocator and renamer block 430 may also be replicated for threads 401a and 401b. Some resources, such as re-order buffers in reorder/retirement unit 435, ILTB 420, load/store buffers, and queues may be shared through partitioning. Other resources, such as general purpose internal registers, page-table base register(s), low-level data-cache and data-TLB 415, execution unit(s) 440, and portions of out-of-order unit 435 are potentially fully shared.

Processor 400 often includes other resources, which may be fully shared, shared through partitioning, or dedicated by/to processing elements. In FIG. 4, an embodiment of a purely exemplary processor with illustrative logical units/resources of a processor is illustrated. Note that a processor may include, or omit, any of these functional units, as well as include any other known functional units, logic, or firmware not depicted. As illustrated, core 401 includes a simplified, representative out-of-order (OOO) processor core. But an in-order processor may be utilized in different embodiments. The OOO core includes a branch target buffer 420 to predict branches to be executed/taken and an instruction-translation buffer (I-TLB) 420 to store address translation entries for instructions.

Core 401 further includes decode module 425 coupled to fetch unit 420 to decode fetched elements. Fetch logic, in one embodiment, includes individual sequencers associated with thread slots 401a, 401b, respectively. Usually core 401 is associated with a first ISA, which defines/specifies instructions executable on processor 400. Often machine code instructions that are part of the first ISA include a portion of the instruction (referred to as an opcode), which references/specifies an instruction or operation to be performed. Decode logic 425 includes circuitry that recognizes these instructions from their opcodes and passes the decoded instructions on in the pipeline for processing as defined by the first ISA. For example, decoders 425, in one embodiment, include logic designed or adapted to recognize specific instructions, such as transactional instruction. As a result of the recognition by decoders 425, the architecture or core 401 takes specific, predefined actions to perform tasks associated with the appropriate instruction. It is important to note that any of the tasks, blocks, operations, and methods described herein may be performed in response to a single or multiple instructions; some of which may be new or old instructions.

In one example, allocator and renamer block 430 includes an allocator to reserve resources, such as register files to store instruction processing results. However, threads 401a and 401b are potentially capable of out-of-order execution, where allocator and renamer block 430 also reserves other resources, such as reorder buffers to track instruction results. Unit 430 may also include a register renamer to rename program/instruction reference registers to other registers internal to processor 400. Reorder/retirement unit 435 includes components, such as the reorder buffers mentioned above, load buffers, and store buffers, to support out-of-order execution and later in-order retirement of instructions executed out-of-order.

Scheduler and execution unit(s) block 440, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 450 are coupled to execution unit(s) 440. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 401 and 402 share access to higher-level or further-out cache 410, which is to cache recently fetched elements. Note that higher-level or further-out refers to cache levels increasing or getting further away from the execution unit(s). In one embodiment, higher-level cache 410 is a last-level data cache—last cache in the memory hierarchy on processor 400—such as a second or third level data cache. However, higher level cache 410 is not so limited, as it may be associated with or includes an instruction cache. A trace cache—a type of instruction cache—instead may be coupled after decoder 425 to store recently decoded traces.

In the depicted configuration, processor 400 also includes bus interface module 405 and a power controller 460, which may perform power management in accordance with an embodiment of the present invention. In this scenario, bus interface 405 is to communicate with devices external to processor 400, such as system memory and other components.

A memory controller 470 may interface with other devices such as one or many memories. In an example, bus interface 405 includes a ring interconnect with a memory controller for interfacing with a memory and a graphics controller for interfacing with a graphics processor. In an SoC environment, even more devices, such as a network interface, coprocessors, memory, graphics processor, and any other known computer devices/interface may be integrated on a single die or integrated circuit to provide small form factor with high functionality and low power consumption.

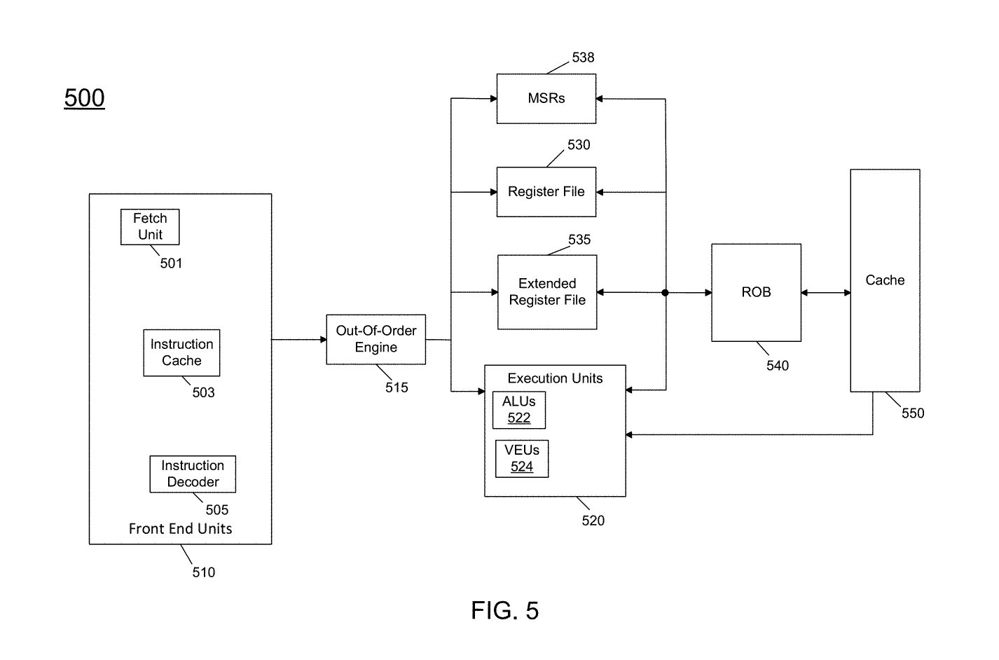

Referring now to FIG. 5, shown is a block diagram of a micro-architecture of a processor core in accordance with one embodiment of the present invention. As shown in FIG. 5, processor core 500 may be a multi-stage pipelined out-of-order processor. Core 500 may operate at various voltages based on a received operating voltage, which may be received from an integrated voltage regulator or external voltage regulator.

As seen in FIG. 5, core 500 includes front end units 510, which may be used to fetch instructions to be executed and prepare them for use later in the processor pipeline. For example, front end units 510 may include a fetch unit 501, an instruction cache 503, and an instruction decoder 505. In some implementations, front end units 510 may further include a trace cache, along with microcode storage as well as a micro-operation storage. Fetch unit 501 may fetch macro-instructions, e.g., from memory or instruction cache 503, and feed them to instruction decoder 505 to decode them into primitives, i.e., micro-operations for execution by the processor.

Coupled between front end units 510 and execution units 520 is an out-of-order (OOO) engine 515 that may be used to receive the micro-instructions and prepare them for execution. More specifically OOO engine 515 may include various buffers to re-order micro-instruction flow and allocate various resources needed for execution, as well as to provide renaming of logical registers onto storage locations within various register files such as register file 530 and extended register file 535. Register file 530 may include separate register files for integer and floating point operations. For purposes of configuration, control, and additional operations, a set of machine specific registers (MSRs) 538 may also be present and accessible to various logic within core 500 (and external to the core).

Various resources may be present in execution units 520, including, for example, various integer, floating point, and single instruction multiple data (SIMD) logic units, among other specialized hardware. For example, such execution units may include one or more arithmetic logic units (ALUs) 522 and one or more vector execution units 524, among other such execution units.

Results from the execution units may be provided to retirement logic, namely a reorder buffer (ROB) 540. More specifically, ROB 540 may include various arrays and logic to receive information associated with instructions that are executed. This information is then examined by ROB 540 to determine whether the instructions can be validly retired and result data committed to the architectural state of the processor, or whether one or more exceptions occurred that prevent a proper retirement of the instructions. Of course, ROB 540 may handle other operations associated with retirement.

As shown in FIG. 5, ROB 540 is coupled to a cache 550 which, in one embodiment may be a low level cache (e.g., an L1 cache) although the scope of the present invention is not limited in this regard. Also, execution units 520 can be directly coupled to cache 550. From cache 550, data communication may occur with higher level caches, system memory and so forth. Note that performance and energy efficiency capabilities of core 500 may vary based on workload and/or processor constraints. As such, a power controller (not shown in FIG. 5) may dynamically determine an appropriate low power state for all or a portion of processor 500 to enter based at least in part on such information, including the performance monitoring information as described herein. While shown with this high level in the embodiment of FIG. 5, understand the scope of the present invention is not limited in this regard. For example, while the implementation of FIG. 5 is with regard to an out-of-order machine such as of an Intel® x86 instruction set architecture (ISA), the scope of the present invention is not limited in this regard. That is, other embodiments may be implemented in an in-order processor, a reduced instruction set computing (RISC) processor such as an ARM-based processor, or a processor of another type of ISA that can emulate instructions and operations of a different ISA via an emulation engine and associated logic circuitry.

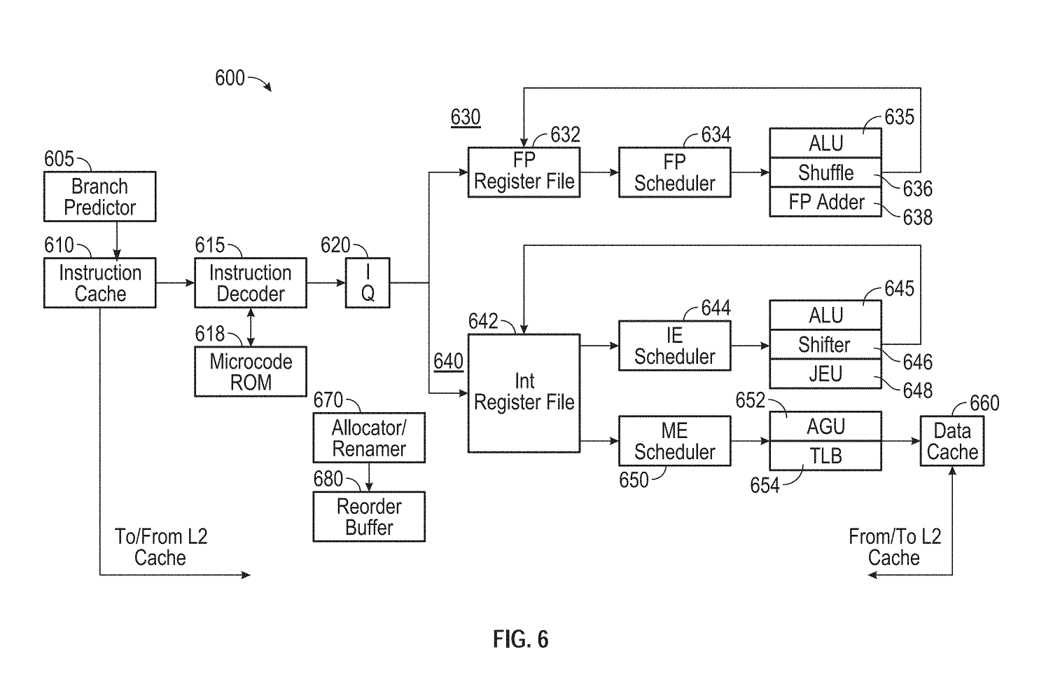

Referring now to FIG. 6, shown is a block diagram of a micro-architecture of a processor core in accordance with another embodiment. In the embodiment of FIG. 6, core 600 may be a low power core of a different micro-architecture, such as an Intel® Atom™-based processor having a relatively limited pipeline depth designed to reduce power consumption. As seen, core 600 includes an instruction cache 610 coupled to provide instructions to an instruction decoder 615. A branch predictor 605 may be coupled to instruction cache 610. Note that instruction cache 610 may further be coupled to another level of a cache memory, such as an L2 cache (not shown for ease of illustration in FIG. 6). In turn, instruction decoder 615 provides decoded instructions to an issue queue 620 for storage and delivery to a given execution pipeline. A microcode ROM 618 is coupled to instruction decoder 615.

A floating point pipeline 630 includes a floating point register file 632 which may include a plurality of architectural registers of a given bit with such as 128, 256 or 512 bits. Pipeline 630 includes a floating point scheduler 634 to schedule instructions for execution on one of multiple execution units of the pipeline. In the embodiment shown, such execution units include an ALU 635, a shuffle unit 636, and a floating point adder 638. In turn, results generated in these execution units may be provided back to buffers and/or registers of register file 632. Of course understand while shown with these few example execution units, additional or different floating point execution units may be present in another embodiment.

An integer pipeline 640 also may be provided. In the embodiment shown, pipeline 640 includes an integer register file 642 which may include a plurality of architectural registers of a given bit with such as 128 or 256 bits. Pipeline 640 includes an integer scheduler 644 to schedule instructions for execution on one of multiple execution units of the pipeline. In the embodiment shown, such execution units include an ALU 645, a shifter unit 646, and a jump execution unit 648. In turn, results generated in these execution units may be provided back to buffers and/or registers of register file 642. Of course understand while shown with these few example execution units, additional or different integer execution units may be present in another embodiment.

A memory execution scheduler 650 may schedule memory operations for execution in an address generation unit 652, which is also coupled to a TLB 654. As seen, these structures may couple to a data cache 660, which may be a L0 and/or L1 data cache that in turn couples to additional levels of a cache memory hierarchy, including an L2 cache memory.

To provide support for out-of-order execution, an allocator/renamer 670 may be provided, in addition to a reorder buffer 680, which is configured to reorder instructions executed out of order for retirement in order. Note that performance and energy efficiency capabilities of core 600 may vary based on workload and/or processor constraints. As such, a power controller (not shown in FIG. 6) may dynamically determine an appropriate low power state for all or a portion of processor 500 to enter based at least in part on such information, including the performance monitoring information, as described herein. Although shown with this particular pipeline architecture in the illustration of FIG. 6, understand that many variations and alternatives are possible.

Note that in a processor having asymmetric cores, such as in accordance with the micro-architectures of FIGS. 5 and 6, workloads may be dynamically swapped between the cores for power management reasons, as these cores, although having different pipeline designs and depths, may be of the same or related ISA. Such dynamic core swapping may be performed in a manner transparent to a user application (and possibly kernel also).

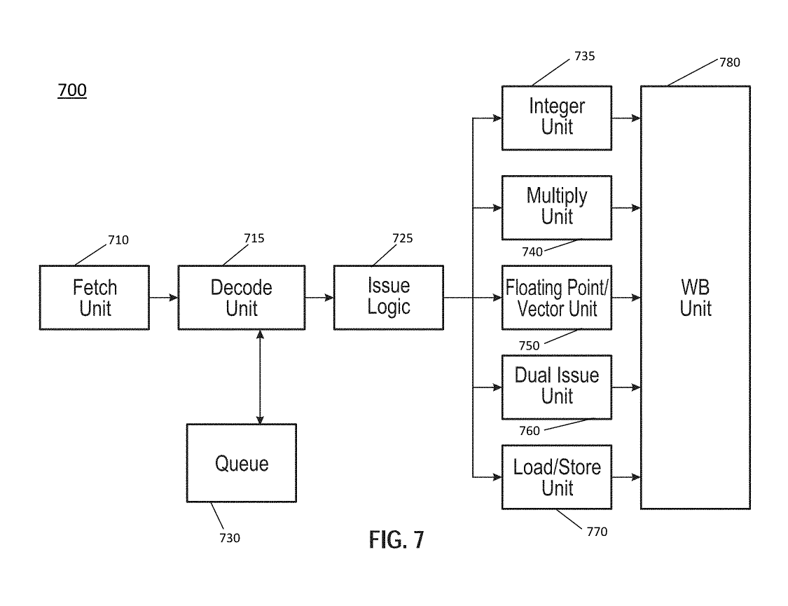

Referring to FIG. 7, shown is a block diagram of a micro-architecture of a processor core in accordance with yet another embodiment. As illustrated in FIG. 7, a core 700 may include a multi-staged in-order pipeline to execute at very low power consumption levels. As one such example, processor 700 may have a micro-architecture in accordance with an ARM Cortex A53 design available from ARM Holdings, LTD., Sunnyvale, Calif. In an implementation, an 8-stage pipeline may be provided that is configured to execute both 32-bit and 64-bit code. Core 700 includes a fetch unit 710 that is configured to fetch instructions and provide them to a decode unit 715, which may decode the instructions, e.g., macro-instructions of a given ISA such as an ARMv8 ISA. Note further that a queue 730 may couple to decode unit 715 to store decoded instructions. Decoded instructions are provided to an issue logic 725, where the decoded instructions may be issued to a given one of multiple execution units.

With further reference to FIG. 7, issue logic 725 may issue instructions to one of multiple execution units. In the embodiment shown, these execution units include an integer unit 735, a multiply unit 740, a floating point/vector unit 750, a dual issue unit 760, and a load/store unit 770. The results of these different execution units may be provided to a writeback unit 780. Understand that while a single writeback unit is shown for ease of illustration, in some implementations separate writeback units may be associated with each of the execution units. Furthermore, understand that while each of the units and logic shown in FIG. 7 is represented at a high level, a particular implementation may include more or different structures. A processor designed using one or more cores having a pipeline as in FIG. 7 may be implemented in many different end products, extending from mobile devices to server systems.

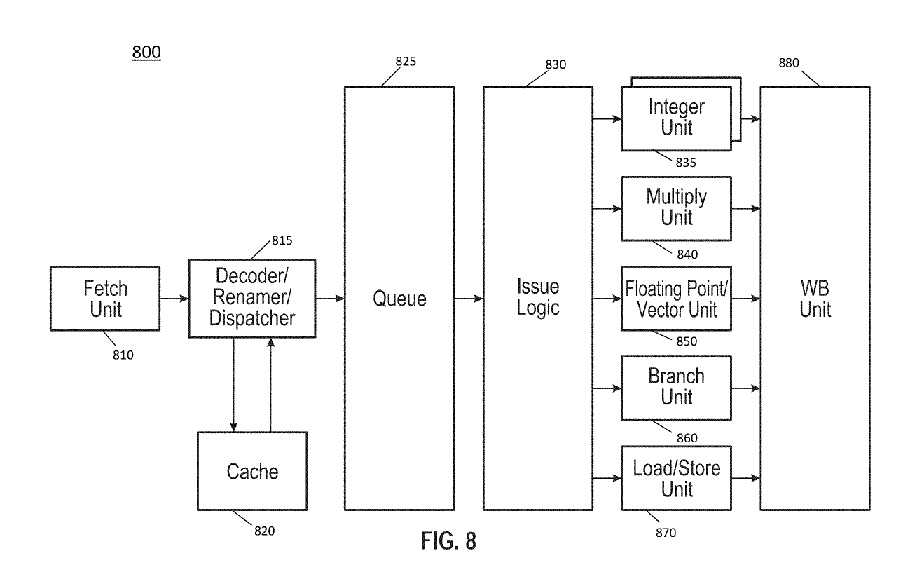

Referring to FIG. 8, shown is a block diagram of a micro-architecture of a processor core in accordance with a still further embodiment. As illustrated in FIG. 8, a core 800 may include a multi-stage multi-issue out-of-order pipeline to execute at very high performance levels (which may occur at higher power consumption levels than core 700 of FIG. 7). As one such example, processor 800 may have a microarchitecture in accordance with an ARM Cortex A57 design. In an implementation, a 15 (or greater)-stage pipeline may be provided that is configured to execute both 32-bit and 64-bit code. In addition, the pipeline may provide for 3 (or greater)-wide and 3 (or greater)-issue operation. Core 800 includes a fetch unit 810 that is configured to fetch instructions and provide them to a decoder/renamer/dispatcher 815, which may decode the instructions, e.g., macro-instructions of an ARMv8 instruction set architecture, rename register references within the instructions, and dispatch the instructions (eventually) to a selected execution unit. Decoded instructions may be stored in a queue 825. Note that while a single queue structure is shown for ease of illustration in FIG. 8, understand that separate queues may be provided for each of the multiple different types of execution units.

Also shown in FIG. 8 is an issue logic 830 from which decoded instructions stored in queue 825 may be issued to a selected execution unit. Issue logic 830 also may be implemented in a particular embodiment with a separate issue logic for each of the multiple different types of execution units to which issue logic 830 couples.

Decoded instructions may be issued to a given one of multiple execution units. In the embodiment shown, these execution units include one or more integer units 835, a multiply unit 840, a floating point/vector unit 850, a branch unit 860, and a load/store unit 870. In an embodiment, floating point/vector unit 850 may be configured to handle SIMD or vector data of 128 or 256 bits. Still further, floating point/vector execution unit 850 may perform IEEE-754 double precision floating-point operations. The results of these different execution units may be provided to a writeback unit 880. Note that in some implementations separate writeback units may be associated with each of the execution units. Furthermore, understand that while each of the units and logic shown in FIG. 8 is represented at a high level, a particular implementation may include more or different structures.

Note that in a processor having asymmetric cores, such as in accordance with the micro-architectures of FIGS. 7 and 8, workloads may be dynamically swapped for power management reasons, as these cores, although having different pipeline designs and depths, may be of the same or related ISA. Such dynamic core swapping may be performed in a manner transparent to a user application (and possibly kernel also).

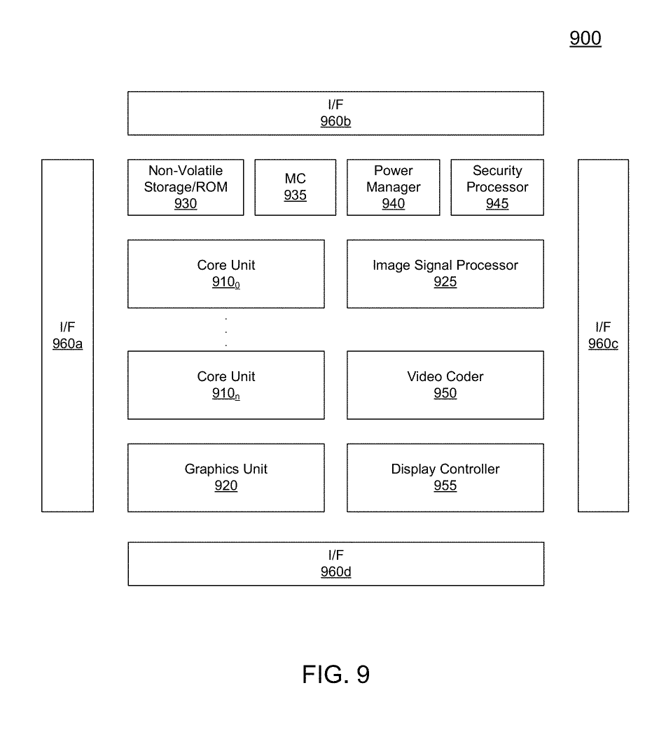

A processor designed using one or more cores having pipelines as in any one or more of FIGS. 5-8 may be implemented in many different end products, extending from mobile devices to server systems. Referring now to FIG. 9, shown is a block diagram of a processor in accordance with another embodiment of the present invention. In the embodiment of FIG. 9, processor 900 may be a SoC including multiple domains, each of which may be controlled to operate at an independent operating voltage and operating frequency. As a specific illustrative example, processor 900 may be an Intel® Architecture Core™-based processor such as an i3, i5, i7 or another such processor available from Intel Corporation. However, other low power processors such as available from Advanced Micro Devices, Inc. (AMD) of Sunnyvale, Calif., an ARM-based design from ARM Holdings, Ltd. or licensee thereof or a MIPS-based design from MIPS Technologies, Inc. of Sunnyvale, Calif., or their licensees or adopters may instead be present in other embodiments such as an Apple A7 processor, a Qualcomm Snapdragon processor, or Texas Instruments OMAP processor. Such SoC may be used in a low power system such as a smartphone, tablet computer, phablet computer, Ultrabook™ computer or other portable computing device, or a vehicle computing system.

In the high level view shown in FIG. 9, processor 900 includes a plurality of core units 910₀-910ₙ. Each core unit may include one or more processor cores, one or more cache memories and other circuitry. Each core unit 910 may support one or more instructions sets (e.g., an x86 instruction set (with some extensions that have been added with newer versions); a MIPS instruction set; an ARM instruction set (with optional additional extensions such as NEON)) or other instruction set or combinations thereof. Note that some of the core units may be heterogeneous resources (e.g., of a different design). In addition, each such core may be coupled to a cache memory (not shown) which in an embodiment may be a shared level (L2) cache memory. A non-volatile storage 930 may be used to store various program and other data. For example, this storage may be used to store at least portions of microcode, boot information such as a BIOS, other system software and other information.

Each core unit 910 may also include an interface such as a bus interface unit to enable interconnection to additional circuitry of the processor. In an embodiment, each core unit 910 couples to a coherent fabric that may act as a primary cache coherent on-die interconnect that in turn couples to a memory controller 935. In turn, memory controller 935 controls communications with a memory such as a DRAM (not shown for ease of illustration in FIG. 9).

In addition to core units, additional processing engines are present within the processor, including at least one graphics unit 920 which may include one or more graphics processing units (GPUs) to perform graphics processing as well as to possibly execute general purpose operations on the graphics processor (so-called GPGPU operation). In addition, at least one image signal processor 925 may be present. Signal processor 925 may be configured to process incoming image data received from one or more capture devices, either internal to the SoC or off-chip.

Other accelerators also may be present. In the illustration of FIG. 9, a video coder 950 may perform coding operations including encoding and decoding for video information, e.g., providing hardware acceleration support for high definition video content. A display controller 955 further may be provided to accelerate display operations including providing support for internal and external displays of a system. In addition, a security processor 945 may be present to perform security operations such as secure boot operations, various cryptography operations and so forth.

Each of the units may have its power consumption controlled via a power manager 940, which may include control logic to perform the various power management techniques described herein, including data driven determination of an appropriate low power state.

In some embodiments, SoC 900 may further include a non-coherent fabric coupled to the coherent fabric to which various peripheral devices may couple. One or more interfaces 960a-960d enable communication with one or more off-chip devices. Such communications may be via a variety of communication protocols such as PCIe™, GPIO, USB, I²C, UART, MIPI, SDIO, DDR, SPI, HDMI, among other types of communication protocols. Although shown at this high level in the embodiment of FIG. 9, understand the scope of the present invention is not limited in this regard.

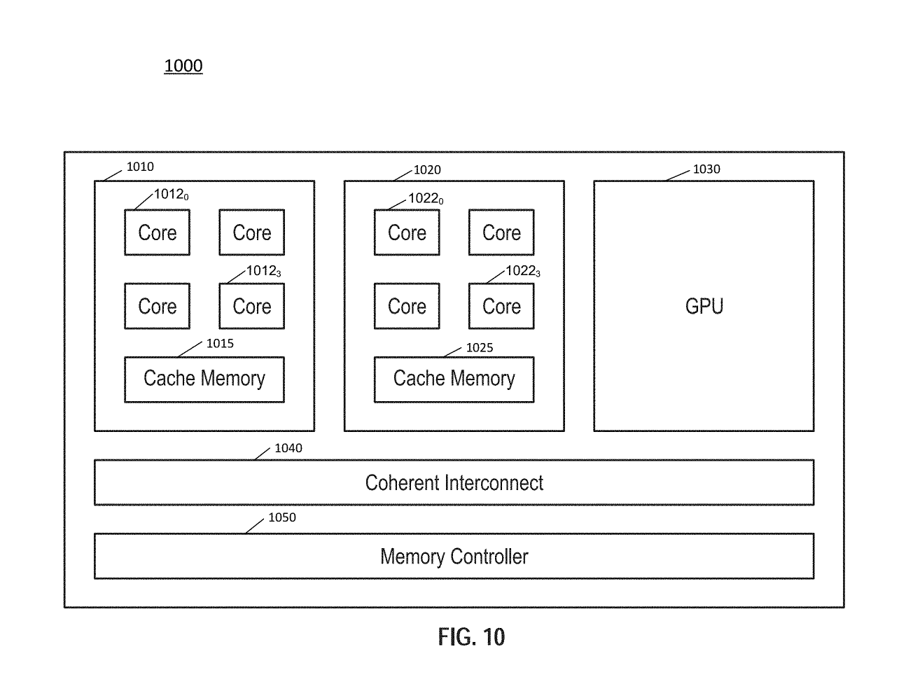

Referring now to FIG. 10, shown is a block diagram of a representative SoC. In the embodiment shown, SoC 1000 may be a multi-core SoC configured for low power operation to be optimized for incorporation into a smartphone or other low power device such as a tablet computer or other portable computing device or vehicle computing system. As an example, SoC 1000 may be implemented using asymmetric or different types of cores, such as combinations of higher power and/or low power cores, e.g., out-of-order cores and in-order cores. In different embodiments, these cores may be based on an Intel® Architecture™ core design or an ARM architecture design. In yet other embodiments, a mix of Intel and ARM cores may be implemented in a given SoC.

As seen in FIG. 10, SoC 1000 includes a first core domain 1010 having a plurality of first cores 1012₀-1012₃. In an example, these cores may be low power cores such as in-order cores as described herein. In one embodiment these first cores may be implemented as ARM Cortex A53 cores. In turn, these cores couple to a cache memory 1015 of core domain 1010. In addition, SoC 1000 includes a second core domain 1020. In the illustration of FIG. 10, second core domain 1020 has a plurality of second cores 1022₀-1022₃. In an example, these cores may be higher power-consuming cores than first cores 1012. In an embodiment, the second cores may be out-of-order cores, which may be implemented as ARM Cortex A57 cores. In turn, these cores couple to a cache memory 1025 of core domain 1020. Note that while the example shown in FIG. 10 includes 4 cores in each domain, understand that more or fewer cores may be present in a given domain in other examples.

With further reference to FIG. 10, a graphics domain 1030 also is provided, which may include one or more graphics processing units (GPUs) configured to independently execute graphics workloads, e.g., provided by one or more cores of core domains 1010 and 1020. As an example, GPU domain 1030 may be used to provide display support for a variety of screen sizes, in addition to providing graphics and display rendering operations.

As seen, the various domains couple to a coherent interconnect 1040, which in an embodiment may be a cache coherent interconnect fabric that in turn couples to an integrated memory controller 1050. Coherent interconnect 1040 may include a shared cache memory, such as an L3 cache, in some examples. In an embodiment, memory controller 1050 may be a direct memory controller to provide for multiple channels of communication with an off-chip memory, such as multiple channels of a DRAM (not shown for ease of illustration in FIG. 10).

In different examples, the number of the core domains may vary. For example, for a low power SoC suitable for incorporation into a mobile computing device, a limited number of core domains such as shown in FIG. 10 may be present. Still further, in such low power SoCs, core domain 1020 including higher power cores may have fewer numbers of such cores. For example, in one implementation two cores 1022 may be provided to enable operation at reduced power consumption levels. In addition, the different core domains may also be coupled to an interrupt controller to enable dynamic swapping of workloads between the different domains.

In yet other embodiments, a greater number of core domains, as well as additional optional IP logic may be present, in that an SoC can be scaled to higher performance (and power) levels for incorporation into other computing devices, such as desktops, servers, high performance computing systems, base stations forth. As one such example, 4 core domains each having a given number of out-of-order cores may be provided. Still further, in addition to optional GPU support (which as an example may take the form of a GPGPU), one or more accelerators to provide optimized hardware support for particular functions (e.g. web serving, network processing, switching or so forth) also may be provided. In addition, an input/output interface may be present to couple such accelerators to off-chip components.

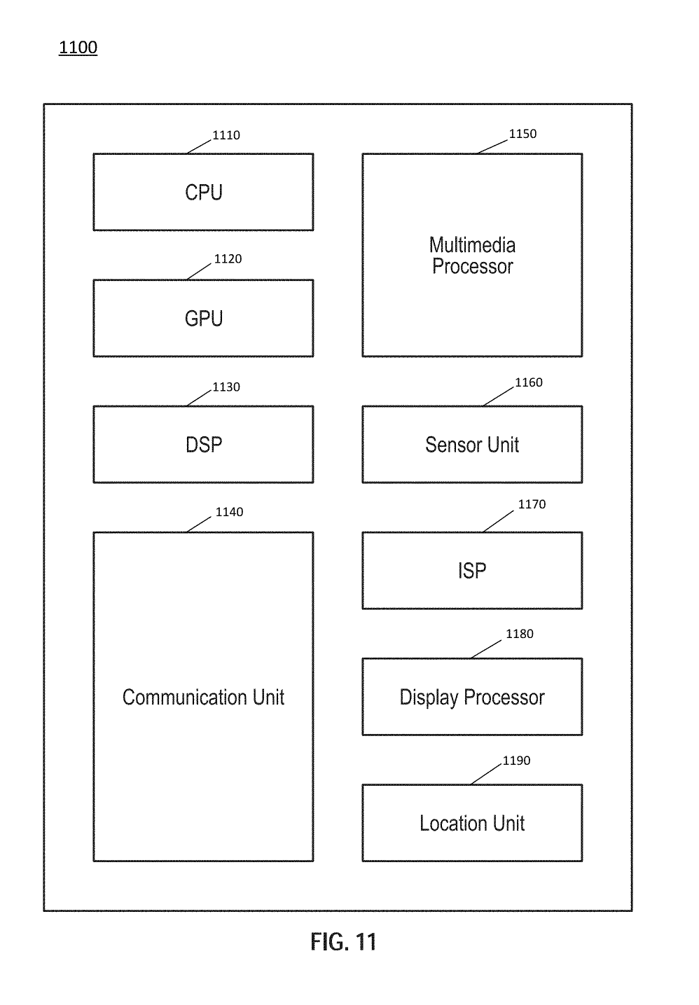

Referring now to FIG. 11, shown is a block diagram of another example SoC. In the embodiment of FIG. 11, SoC 1100 may include various circuitry to enable high performance for multimedia applications, communications and other functions. As such, SoC 1100 is suitable for incorporation into a wide variety of portable and other devices, such as smartphones, tablet computers, smart TVs, vehicle computing systems, and so forth. In the example shown, SoC 1100 includes a central processor unit (CPU) domain 1110. In an embodiment, a plurality of individual processor cores may be present in CPU domain 1110. As one example, CPU domain 1110 may be a quad core processor having 4 multithreaded cores. Such processors may be homogeneous or heterogeneous processors, e.g., a mix of low power and high power processor cores.

In turn, a GPU domain 1120 is provided to perform advanced graphics processing in one or more GPUs to handle graphics and compute APIs. A DSP unit 1130 may provide one or more low power DSPs for handling low-power multimedia applications such as music playback, audio/video and so forth, in addition to advanced calculations that may occur during execution of multimedia instructions. In turn, a communication unit 1140 may include various components to provide connectivity via various wireless protocols, such as cellular communications (including 3G/4G LTE), wireless local area protocols such as Bluetooth™ IEEE 802.11, and so forth.

Still further, a multimedia processor 1150 may be used to perform capture and playback of high definition video and audio content, including processing of user gestures. A sensor unit 1160 may include a plurality of sensors and/or a sensor controller to interface to various off-chip sensors present in a given platform. An image signal processor 1170 may be provided with one or more separate ISPs to perform image processing with regard to captured content from one or more cameras of a platform, including still and video cameras.

A display processor 1180 may provide support for connection to a high definition display of a given pixel density, including the ability to wirelessly communicate content for playback on such display. Still further, a location unit 1190 may include a GPS receiver with support for multiple GPS constellations to provide applications highly accurate positioning information obtained using as such GPS receiver. Understand that while shown with this particular set of components in the example of FIG. 11, many variations and alternatives are possible.

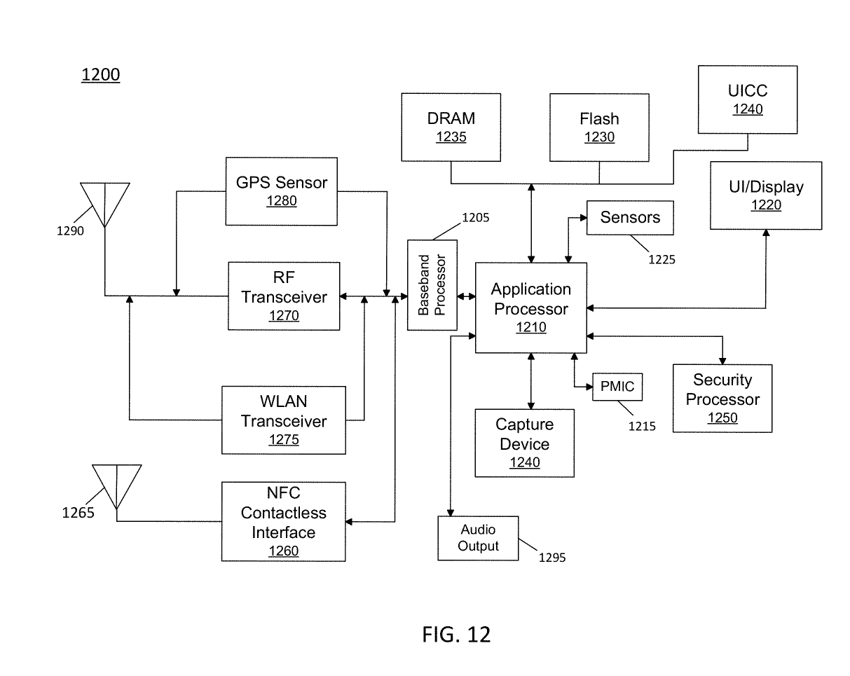

Referring now to FIG. 12, shown is a block diagram of an example system with which embodiments can be used. As seen, system 1200 may be a smartphone or other wireless communicator. A baseband processor 1205 is configured to perform various signal processing with regard to communication signals to be transmitted from or received by the system. In turn, baseband processor 1205 is coupled to an application processor 1210, which may be a main CPU of the system to execute an OS and other system software, in addition to user applications such as many well-known social media and multimedia apps. Application processor 1210 may include a power controller as described herein, and may further be configured to perform a variety of other computing operations for the device.

In turn, application processor 1210 can couple to a user interface/display 1220, e.g., a touch screen display. In addition, application processor 1210 may couple to a memory system including a non-volatile memory, namely a flash memory 1230 and a system memory, namely a dynamic random access memory (DRAM) 1235. As further seen, application processor 1210 further couples to a capture device 1240 such as one or more image capture devices that can record video and/or still images.

Still referring to FIG. 12, a universal integrated circuit card (UICC) 1240 comprising a subscriber identity module and possibly a secure storage and cryptoprocessor is also coupled to application processor 1210. System 1200 may further include a security processor 1250 that may couple to application processor 1210. A plurality of sensors 1225 may couple to application processor 1210 to enable input of a variety of sensed information such as accelerometer and other environmental information. An audio output device 1295 may provide an interface to output sound, e.g., in the form of voice communications, played or streaming audio data and so forth.

As further illustrated, a near field communication (NFC) contactless interface 1260 is provided that communicates in a NFC near field via an NFC antenna 1265. While separate antennae are shown in FIG. 12, understand that in some implementations one antenna or a different set of antennae may be provided to enable various wireless functionality.

A power management integrated circuit (PMIC) 1215 couples to application processor 1210 to perform platform level power management. To this end, PMIC 1215 may issue power management requests to application processor 1210 to enter certain low power states as desired. Furthermore, based on platform constraints, PMIC 1215 may also control the power level of other components of system 1200.

To enable communications to be transmitted and received, various circuitry may be coupled between baseband processor 1205 and an antenna 1290. Specifically, a radio frequency (RF) transceiver 1270 and a wireless local area network (WLAN) transceiver 1275 may be present. In general, RF transceiver 1270 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 1280 may be present. Other wireless communications such as receipt or transmission of radio signals, e.g., AM/FM and other signals may also be provided. In addition, via WLAN transceiver 1275, local wireless communications can also be realized.

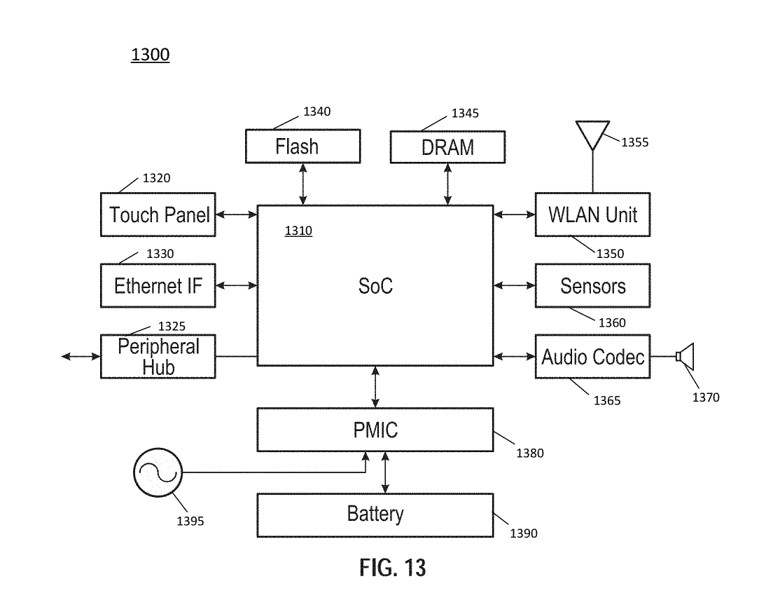

Referring now to FIG. 13, shown is a block diagram of another example system with which embodiments may be used. In the illustration of FIG. 13, system 1300 may be mobile low-power system such as a tablet computer, 2:1 tablet, phablet or other convertible or standalone tablet system. As illustrated, a SoC 1310 is present and may be configured to operate as an application processor for the device and which may include a power controller as described herein.

A variety of devices may couple to SoC 1310. In the illustration shown, a memory subsystem includes a flash memory 1340 and a DRAM 1345 coupled to SoC 1310. In addition, a touch panel 1320 is coupled to the SoC 1310 to provide display capability and user input via touch, including provision of a virtual keyboard on a display of touch panel 1320. To provide wired network connectivity, SoC 1310 couples to an Ethernet interface 1330. A peripheral hub 1325 is coupled to SoC 1310 to enable interfacing with various peripheral devices, such as may be coupled to system 1300 by any of various ports or other connectors.

In addition to internal power management circuitry and functionality within SoC 1310, a PMIC 1380 is coupled to SoC 1310 to provide platform-based power management, e.g., based on whether the system is powered by a battery 1390 or AC power via an AC adapter 1395. In addition to this power source-based power management, PMIC 1380 may further perform platform power management activities based on environmental and usage conditions. Still further, PMIC 1380 may communicate control and status information to SoC 1310 to cause various power management actions within SoC 1310.

Still referring to FIG. 13, to provide for wireless capabilities, a WLAN unit 1350 is coupled to SoC 1310 and in turn to an antenna 1355. In various implementations, WLAN unit 1350 may provide for communication according to one or more wireless protocols.

As further illustrated, a plurality of sensors 1360 may couple to SoC 1310. These sensors may include various accelerometer, environmental and other sensors, including user gesture sensors. Finally, an audio codec 1365 is coupled to SoC 1310 to provide an interface to an audio output device 1370. Of course understand that while shown with this particular implementation in FIG. 13, many variations and alternatives are possible.

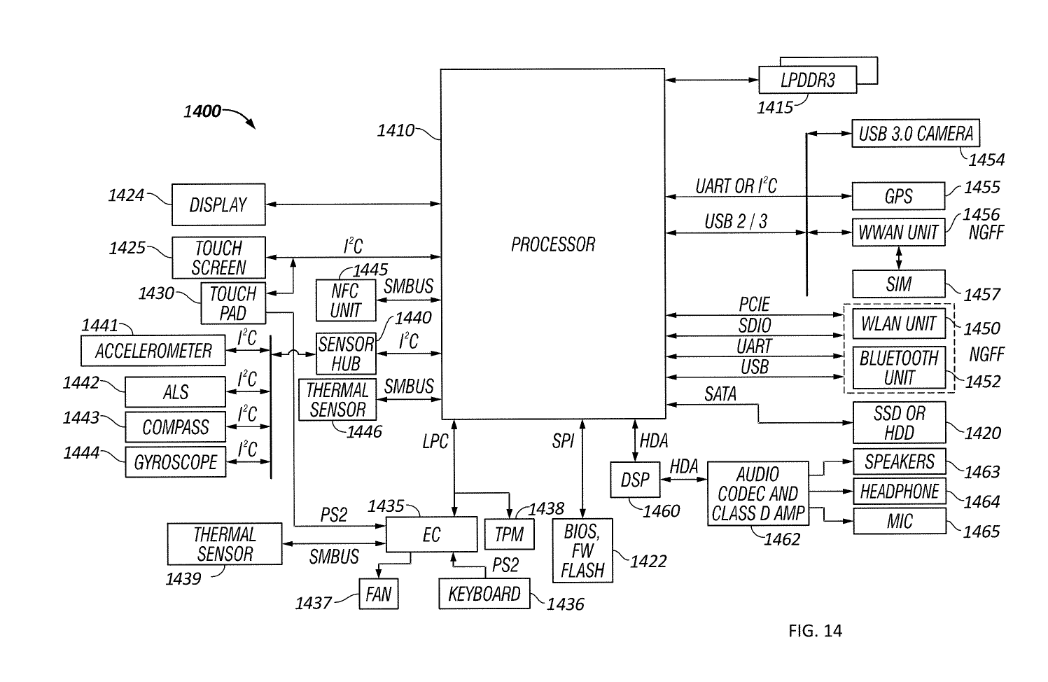

Referring now to FIG. 14, shown is a block diagram of a representative computer system such as notebook, Ultrabook™ or other small form factor system. A processor 1410, in one embodiment, includes a microprocessor, multi-core processor, multithreaded processor, an ultra low voltage processor, an embedded processor, or other known processing element. In the illustrated implementation, processor 1410 acts as a main processing unit and central hub for communication with many of the various components of the system 1400. As one example, processor 1400 is implemented as a SoC and which may include a power controller as described herein.

Processor 1410, in one embodiment, communicates with a system memory 1415. As an illustrative example, the system memory 1415 is implemented via multiple memory devices or modules to provide for a given amount of system memory.

To provide for persistent storage of information such as data, applications, one or more operating systems and so forth, a mass storage 1420 may also couple to processor 1410. In various embodiments, to enable a thinner and lighter system design as well as to improve system responsiveness, this mass storage may be implemented via a SSD or the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also shown in FIG. 14, a flash device 1422 may be coupled to processor 1410, e.g., via a serial peripheral interface (SPI). This flash device may provide for non-volatile storage of system software, including a basic input/output software (BIOS) as well as other firmware of the system.

Various input/output (I/O) devices may be present within system 1400. Specifically shown in the embodiment of FIG. 14 is a display 1424 which may be a high definition LCD or LED panel that further provides for a touch screen 1425. In one embodiment, display 1424 may be coupled to processor 1410 via a display interconnect that can be implemented as a high performance graphics interconnect. Touch screen 1425 may be coupled to processor 1410 via another interconnect, which in an embodiment can be an I²C interconnect. As further shown in FIG. 14, in addition to touch screen 1425, user input by way of touch can also occur via a touch pad 1430 which may be configured within the chassis and may also be coupled to the same I²C interconnect as touch screen 1425.

For perceptual computing and other purposes, various sensors may be present within the system and may be coupled to processor 1410 in different manners. Certain inertial and environmental sensors may couple to processor 1410 through a sensor hub 1440, e.g., via an I²C interconnect. In the embodiment shown in FIG. 14, these sensors may include an accelerometer 1441, an ambient light sensor (ALS) 1442, a compass 1443 and a gyroscope 1444. Other environmental sensors may include one or more thermal sensors 1446 which in some embodiments couple to processor 1410 via a system management bus (SMBus) bus.

Also seen in FIG. 14, various peripheral devices may couple to processor 1410 via a low pin count (LPC) interconnect. In the embodiment shown, various components can be coupled through an embedded controller 1435. Such components can include a keyboard 1436 (e.g., coupled via a PS2 interface), a fan 1437, and a thermal sensor 1439. In some embodiments, touch pad 1430 may also couple to EC 1435 via a PS2 interface. In addition, a security processor such as a trusted platform module (TPM) 1438 may also couple to processor 1410 via this LPC interconnect.

System 1400 can communicate with external devices in a variety of manners, including wirelessly. In the embodiment shown in FIG. 14, various wireless modules, each of which can correspond to a radio configured for a particular wireless communication protocol, are present. One manner for wireless communication in a short range such as a near field may be via a NFC unit 1445 which may communicate, in one embodiment with processor 1410 via an SMBus. Note that via this NFC unit 1445, devices in close proximity to each other can communicate.

As further seen in FIG. 14, additional wireless units can include other short range wireless engines including a WLAN unit 1450 and a Bluetooth unit 1452. Using WLAN unit 1450, Wi-Fi™ communications can be realized, while via Bluetooth unit 1452, short range Bluetooth™ communications can occur. These units may communicate with processor 1410 via a given link.

In addition, wireless wide area communications, e.g., according to a cellular or other wireless wide area protocol, can occur via a WWAN unit 1456 which in turn may couple to a subscriber identity module (SIM) 1457. In addition, to enable receipt and use of location information, a GPS module 1455 may also be present. Note that in the embodiment shown in FIG. 14, WWAN unit 1456 and an integrated capture device such as a camera module 1454 may communicate via a given link.

An integrated camera module 1454 can be incorporated in the lid. To provide for audio inputs and outputs, an audio processor can be implemented via a digital signal processor (DSP) 1460, which may couple to processor 1410 via a high definition audio (HDA) link. Similarly, DSP 1460 may communicate with an integrated coder/decoder (CODEC) and amplifier 1462 that in turn may couple to output speakers 1463 which may be implemented within the chassis. Similarly, amplifier and CODEC 1462 can be coupled to receive audio inputs from a microphone 1465 which in an embodiment can be implemented via dual array microphones (such as a digital microphone array) to provide for high quality audio inputs to enable voice-activated control of various operations within the system. Note also that audio outputs can be provided from amplifier/CODEC 1462 to a headphone jack 1464. Although shown with these particular components in the embodiment of FIG. 14, understand the scope of the present invention is not limited in this regard.

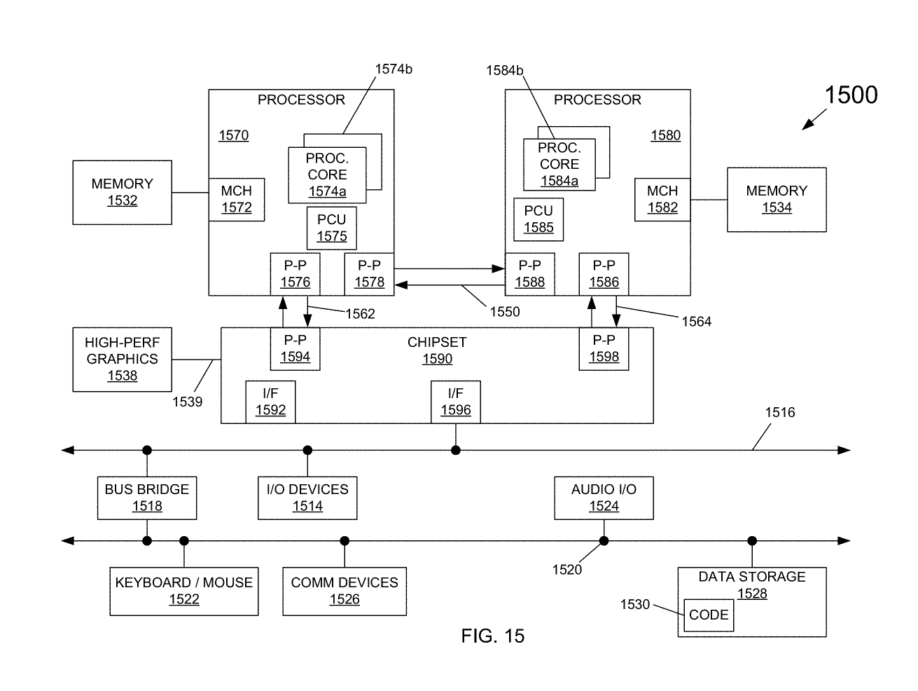

Embodiments may be implemented in many different system types. Referring now to FIG. 15, shown is a block diagram of a system in accordance with an embodiment of the present invention. As shown in FIG. 15, multiprocessor system 1500 is a point-to-point interconnect system, and includes a first processor 1570 and a second processor 1580 coupled via a point-to-point interconnect 1550. As shown in FIG. 15, each of processors 1570 and 1580 may be multicore processors, including first and second processor cores (i.e., processor cores 1574a and 1574b and processor cores 1584a and 1584b), although potentially many more cores may be present in the processors. Each of the processors can include a PCU 1575, 1585 or other power management logic to perform processor-based power management as described herein. To this end, PCUs 1575 and 1585 may include low power control circuitry to dynamically determine, based at least in part on incoming performance monitoring information on which pipeline cost metadata can be determined, an appropriate low power state for all or a portion of the processor to enter. As such, this low power control circuitry may cause entry into a different low power state than that requested, which can be a demoted or promoted low power state, as described herein.

Still referring to FIG. 15, first processor 1570 further includes a memory controller hub (MCH) 1572 and point-to-point (P-P) interfaces 1576 and 1578. Similarly, second processor 1580 includes a MCH 1582 and P-P interfaces 1586 and 1588. As shown in FIG. 15, MCH's 1572 and 1582 couple the processors to respective memories, namely a memory 1532 and a memory 1534, which may be portions of system memory (e.g., DRAM) locally attached to the respective processors. First processor 1570 and second processor 1580 may be coupled to a chipset 1590 via P-P interconnects 1562 and 1564, respectively. As shown in FIG. 15, chipset 1590 includes P-P interfaces 1594 and 1598.

Furthermore, chipset 1590 includes an interface 1592 to couple chipset 1590 with a high performance graphics engine 1538, by a P-P interconnect 1539. In turn, chipset 1590 may be coupled to a first bus 1516 via an interface 1596. As shown in FIG. 15, various input/output (I/O) devices 1514 may be coupled to first bus 1516, along with a bus bridge 1518 which couples first bus 1516 to a second bus 1520. Various devices may be coupled to second bus 1520 including, for example, a keyboard/mouse 1522, communication devices 1526 and a data storage unit 1528 such as a disk drive or other mass storage device which may include code 1530, in one embodiment. Further, an audio I/O 1524 may be coupled to second bus 1520. Embodiments can be incorporated into other types of systems including mobile devices such as a smart cellular telephone, tablet computer, netbook, Ultrabook™, or so forth.

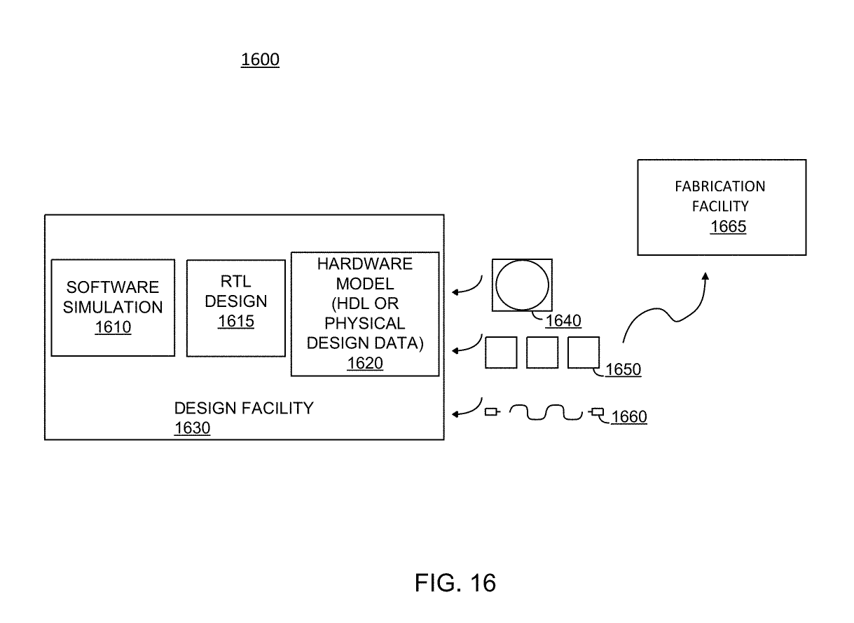

FIG. 16 is a block diagram illustrating an IP core development system 1600 that may be used to manufacture an integrated circuit to perform operations according to an embodiment. The IP core development system 1600 may be used to generate modular, re-usable designs that can be incorporated into a larger design or used to construct an entire integrated circuit (e.g., an SoC integrated circuit). A design facility 1630 can generate a software simulation 1610 of an IP core design in a high level programming language (e.g., C/C++). The software simulation 1610 can be used to design, test, and verify the behavior of the IP core. A register transfer level (RTL) design can then be created or synthesized from the simulation model. The RTL design 1615 is an abstraction of the behavior of the integrated circuit that models the flow of digital signals between hardware registers, including the associated logic performed using the modeled digital signals. In addition to an RTL design 1615, lower-level designs at the logic level or transistor level may also be created, designed, or synthesized. Thus, the particular details of the initial design and simulation may vary.

The RTL design 1615 or equivalent may be further synthesized by the design facility into a hardware model 1620, which may be in a hardware description language (HDL), or some other representation of physical design data. The HDL may be further simulated or tested to verify the IP core design. The IP core design can be stored for delivery to a third party fabrication facility 1665 using non-volatile memory 1640 (e.g., hard disk, flash memory, or any non-volatile storage medium). Alternately, the IP core design may be transmitted (e.g., via the Internet) over a wired connection 1650 or wireless connection 1660. The fabrication facility 1665 may then fabricate an integrated circuit that is based at least in part on the IP core design. The fabricated integrated circuit can be configured to perform operations in accordance with at least one embodiment described herein.

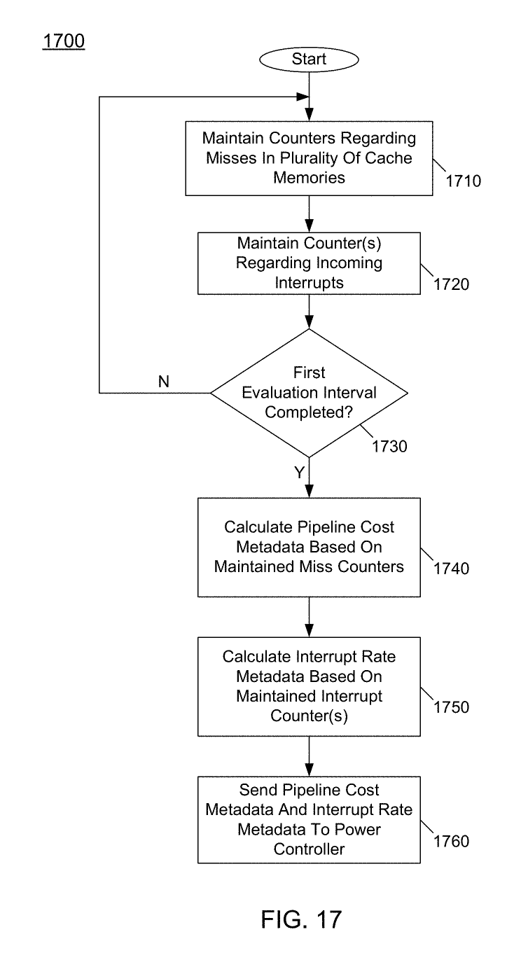

Referring now to FIG. 17, shown is a flow diagram of a method in accordance with an embodiment of the present invention. As shown in FIG. 17, method 1700 is a method for maintaining performance monitoring information by a performance monitoring unit of a processor. As such, method 1700 may be performed by hardware circuitry, firmware, software and/or combinations thereof. As illustrated, method 1700 begins by maintaining counters regarding misses in various cache memories of the processor (block 1710). More specifically, a performance monitor may include a number of counters. Some of these counters may be associated with particular levels of cache memories, including instruction caches, data caches, translation lookaside buffers and so forth. In embodiments, the performance monitor may be configured to maintain counters to count misses within various levels of cache memories of a cache memory hierarchy of the processor. Such information may be used in various ways during operation in the processor, in debug operations and so forth. And more particularly as described herein, such miss information may, along with other data, be used to drive power management decisions in a power controller.

In one embodiment, load and/or store misses for various cache memories may be used to generate, in the performance monitor, ratio information as to the cost of such misses (e.g., number of misses per a given number of unhalted clock cycles). Although the scope of the present invention is not limited in this regard, cache memories for which statistics may be maintained and cost metadata reported to a power controller may include ITLB, DTLB, L1I, L1D, L2 and L3.

Still with reference to FIG. 17, control next passes to block 1720 where one or more counters may be maintained regarding incoming interrupts. For example, one or more counters of the performance monitor may be provided to maintain count information regarding interrupts of different types. Next at diamond 1730 it is determined whether a first evaluation interval is completed. This first evaluation interval may correspond to a time duration at which performance monitoring information is analyzed to generate and provide resulting metadata to a power controller for use as described herein. Although the scope of the present invention is not limited in this regard, this first evaluation interval may be on the order of between approximately 1 millisecond and 1 second. If any of these ratios when coming out of expected C-states exceed a given threshold (e.g., more than 10% of active cycles (C0) time), then entry into that low power state is prevented. If this first evaluation interval has not yet completed, control passes back to block 1710. Otherwise, control passes to block 1740.

At block 1740, pipeline cost metadata may be calculated. More specifically, for purposes of use herein, at least some of the counters that maintain miss information may be analyzed to determine a pipeline cost of the effect of such misses due to particular low power states. As an example, this pipeline cost may be determined in terms of percentage of total machine unhalted C0 active cycles that the pipeline is blocked in response to the cache misses. Next control passes to block 1750 where interrupt rate metadata may be calculated based on the maintained interrupt counters. In an embodiment, this interrupt rate metadata may be calculated using the one or more counters that maintain a count of incoming interrupts. As an example, this interrupt rate metadata may be expressed in terms of interrupts per a given time duration (e.g., the first evaluation interval, per second, or so forth).

Finally with regard to FIG. 17, control next passes to block 1760 where the pipeline cost metadata and the interrupt rate metadata may be sent to the power controller. In one embodiment, a dedicated interconnect may be provided to communicate this metadata from the performance monitor to the power controller. In other cases, a generic processor interconnect architecture may be used to communicate this information. Understand while shown at this high level in the embodiment of FIG. 17, many variations and alternatives are possible. For example, understand that the particular described performance monitoring counters, maintained information and resulting metadata may be only some of the types of performance monitoring information maintained and analyzed within a processor as described herein. Also it is possible to send raw counter data to the power controller and have the power controller determine pipeline cost based on the communicated information.

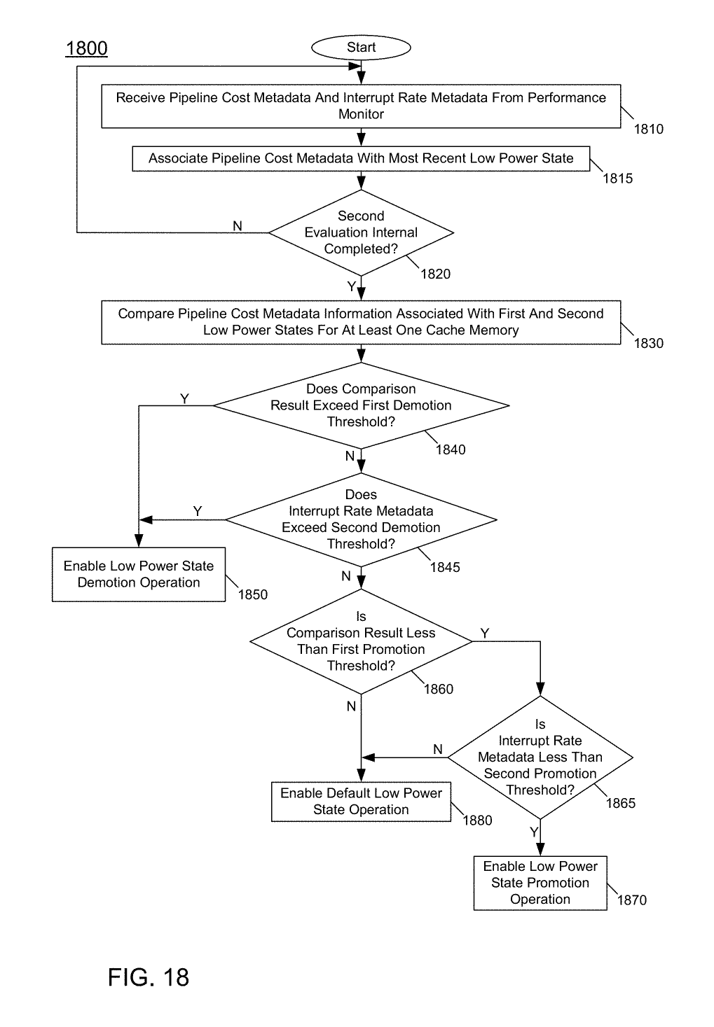

Referring now to FIG. 18, shown is a flow diagram of another method in accordance with an embodiment of the present invention. More specifically as shown in FIG. 18, method 1800 is a method for receiving and using performance monitoring information in a power controller of a processor. As such, method 1800 may be performed by hardware circuitry, firmware, software and/or combinations thereof. As illustrated, method 1800 begins by receiving pipeline cost metadata and interrupt rate metadata from the performance monitor (block 1810). For example as discussed above such information may be communicated on a dedicated path coupled between the performance monitor and the power controller. Next, control passes to block 1815, where the received pipeline cost metadata may be associated with a most recent low power state. For example, assume that the previous (most recent) low power state that occurred in the processor (or relevant portion) was a C6 state. In this instance, this incoming pipeline cost metadata may be associated with the C6 or other deeper low power state. For example, the incoming pipeline cost metadata may be accumulated with additional pipeline cost metadata associated with the C6 or other deeper low power state for earlier iterations of receipt of such incoming performance monitoring information.

Next it is determined whether a second evaluation interval has completed (diamond 1820). More specifically, this second evaluation interval may be of a longer duration than the first evaluation interval, such that performance monitoring information from multiple first evaluation intervals can be considered. If it is determined that the second evaluation interval has not completed, control passes back to block 1810 for receipt and handling of additional performance monitoring information.

Otherwise if it determined that the second evaluation interval has completed, control passes to block 1830 where pipeline cost metadata information for first and second low power states can be compared for at least one cache memory. Nevertheless, while for ease of illustration method 1800 is shown where this comparison of the pipeline cost metadata is for only one cache memory, it is possible for the comparison operations to be performed for multiple cache levels. In such situations, the further determinations described in FIG. 18 may be based on these multiple comparisons. As such, there may be different techniques for weighting the comparisons of pipeline cost metadata information for multiple cache levels, in which the multiple comparison results may be considered. Or only a selected one or subset of these comparison results may be used as the basis for the determinations herein.

For purposes of discussion herein, assume that the comparison performed at block 1830 is for analysis of pipeline cost metadata for a single cache memory. Further, assume that this cache memory of interest is a first level TLB. Also assume that the first and second low power states are, respectively, a C1 low power state and a C6 low power state. The comparison may entail analyzing a difference in relative pipeline cost based on pipeline cost metadata for the first level TLB. More specifically, the accumulated pipeline cost metadata for these two different low power states regarding the first level TLB may provide an indication of the cost to the processor pipeline due to misses occurring in the first level TLB during operation of the processor pipeline in times following exit from the first low power state and the second low power state. The comparison of the impact of the TLB misses on the instruction pipeline when deeper sleep states are successfully entered as compared to when not drives the decision on whether to enter the deeper sleep states in the future. Stated another way, the TLB is flushed prior to C6 entry, but not flushed prior to C1 entry, and as a result greater miss rates occur following C6 exit than following C1 exit.

Next, control passes to diamond 1840 to determine whether the comparison result exceeds a first demotion threshold. This first demotion threshold may correspond to a given percentage difference between the cost values. In a particular embodiment, this first demotion threshold may be set at a level of approximately 10% (of course other examples are possible). Stated another way, this determination thus considers whether the pipeline cost of flushes due to a C6 low power state entry (and resulting misses following C6 state exit) is more than 10% greater than the cost due to misses following a C1 low power state entry and exit. These misses following C1 state act as a baseline measure to determine natural workload miss rate since the TLB is not flushed prior to entry into the C1 state.

If it is determined at diamond 1840 that the comparison result exceeds the first demotion threshold (meaning that there is a relatively large cost to the processor pipeline due to deeper low power state operation), control may proceed directly to block 1850 for enabling low power state demotion operation. That is, based upon the considerations of the pipeline cost metadata, undesired performance impacts may be occurring when the processor enters deeper low power states. As such, low power state demotion operation is enabled, where a power controller may, based upon this data, override incoming software-based low power state requests for deeper low power states to cause the processor to enter into shallower low power states.

Still with reference to FIG. 18, if instead it is determined at diamond 1840 that the comparison result does not exceed the first demotion threshold, control passes to diamond 1845. Note that in some embodiments, this determination at diamond 1845 regarding interrupt rate analysis may be an optional process that may not occur depending upon configuration of the processor, operating conditions or so forth. If this optional determination proceeds, an analysis of interrupt rate metadata occurs. More specifically as shown in FIG. 18, it is determined whether the interrupt rate metadata exceeds a second demotion threshold. This second demotion threshold may be set at an interrupt level at which an undesired performance penalty may be incurred if a processor was in a given low power state. As one example, this second demotion threshold may be on the order of an interrupt rate between approximately 10 and 15 k interrupts per second. Note that this second demotion threshold may be based at least in part on analysis of latencies for entry into and exit from the given low power state, which may act as a baseline to identify whether an undesirable performance cost may occur due to incoming interrupts, should the processor (or relevant core) be placed into the particular low power state.

If the determination at diamond 1845 is in the affirmative, control similarly passes to block 1850 where low power state demotion operation is enabled. Thus as illustrated in FIG. 18, a determination to enable low power state demotion operation (at block 1850) may proceed on a single one of multiple considerations (or potentially dual considerations). That is, it is possible for demotion operation to proceed in response to both determinations finding that the relevant metadata exceeds the given demotion threshold. As such in different embodiments, it is possible for control of low power state demotion operation to be based a single one or both of interrupt rate metadata and pipeline cost metadata analysis. And of course in other embodiments, additional or different considerations with regard to other metadata received from a performance monitor can be used to perform data driven demotion (or promotion control, discussed further below).

To enable the power controller to operate in the low power state demotion mode, the power controller may set an indicator in a configuration register or other location to provide an indication that the power controller is now configured for operation in this low power state demotion mode. As such, when an incoming low power state request is received, the power controller may access this indicator to determine appropriate handling of the request, as described further below.

Still with reference to FIG. 18, if the determinations at diamonds 1840 and 1845 are in the negative (in embodiments in which both operations are performed), control next passes to diamond 1860 to determine whether the comparison result of the pipeline cost metadata information is less than a first promotion threshold (diamond 1860). This first promotion threshold may correspond to a given percentage difference between the cost values. In a particular embodiment, this first promotion threshold may be set at a level of less than approximately 2-3% (of course other examples are possible). Stated another way, this determination thus considers whether the pipeline cost of flushes due to a C6 or higher low power state entry (and resulting misses following C6 state exit) is less than a few percent greater than the cost due to misses following a C1 low power state entry and exit.

If it is determined at diamond 1860 that there is a limited cost due to deeper low power state operation, control next passes to diamond 1865, where it is determined whether the interrupt rate metadata is less than a second promotion threshold. This second promotion threshold may be set at a relatively low interrupt level below which there would not be an undesired performance penalty if a processor was in a relatively deeper low power state.

If the determination at diamond 1865 is in the affirmative, control passes to block 1870 where low power state promotion operation is enabled. As such, a power controller may, based upon this data, override incoming software-based low power state requests for shallower low power states to cause the processor to enter into deeper low power states. Note that in the embodiment of FIG. 18, promotion mode may be enabled only where the two comparisons at diamonds 1860 and 1865 are in the affirmative, to ensure that there is no performance impact due to entry into deeper low power states. Of course, other techniques to enable low power state promotion operation may occur in other different embodiments.

Still with reference to FIG. 18, if instead it is determined at diamond 1860 or diamond 1865 that the comparison result is not less than the first or second promotion threshold, control passes to block 1880, where the power controller may be enabled for default low power state operation. As such, when a given software entity requests a particular low power state, there is no promotion or demotion of the requested state based upon the incoming data, namely the pipeline cost metadata or interrupt rate metadata. Regardless, it is still possible for the power controller to select a different low power state than that requested, e.g., due to workload requirements, processor constraints or so forth. Understand while shown at this high level in the embodiment of FIG. 18, many variations and alternatives are possible.

For example, in some embodiments demotion/promotion operation may not be in the context of selection of different low power states, such as different ACPI C-states. Instead in some embodiments, when demotion/promotion control is enabled, fine-grained power control modifications may occur. For example, when demotion operation is indicated, instead of causing a core/processor to enter into a shallower low power state, a different combination of power management activities of the requested low power state may occur. For example, assume an incoming software entity requests a low power state in which three particular cache memories are flushed. In this instance, the fine-grained control may determine, based at least in part on the pipeline cost metadata, that less than three (e.g., 0, 1 or 2) cache memories may have their contents flushed, while otherwise entering into the requested low power state. And still further, other power management control variations are possible. For example, if DTLB misses are the primary factor impacting C0 cycles between the deeper and shallower C-states, then the power controller may determine to not flush the DTLB but continue to flush the L1I cache and ITLB. Additional examples may include the determination as to whether certain clocks should be gated or not at a given state (e.g., in C3 state certain clocks may typically be gated off, but the PCU may decide to leave one or more of these clocks enabled); determination as to whether certain voting rights of a core or other entity (for frequency states or package level C-states) may or may not be lost at a given low power state.

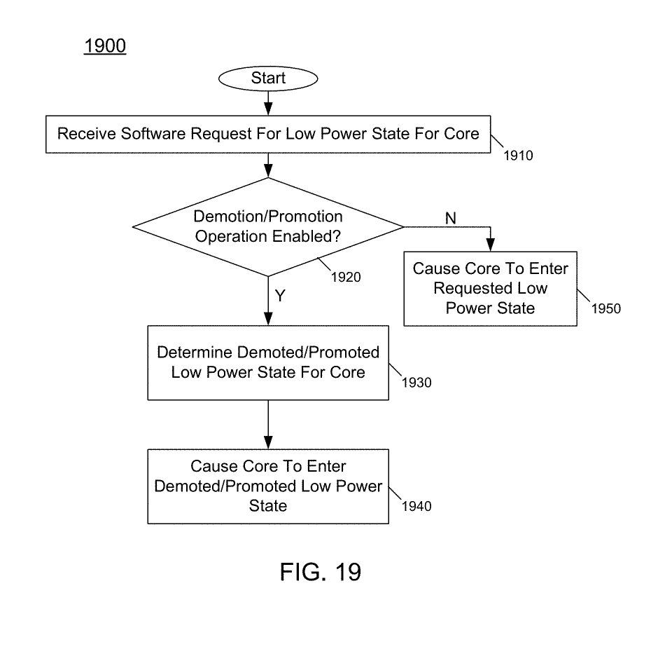

Referring now to FIG. 19, shown is a flow diagram of a method in accordance with yet another embodiment of the present invention. As shown in FIG. 19, method 1900 is a method for controlling entry of a processing unit, e.g., a core, into a particular low power state in response to an incoming low power state request. As such, method 1900 may be performed by a power controller of a processor, such as implemented in hardware circuitry, firmware, software and/or combinations thereof. As illustrated, method 1900 begins by receiving a software request for a low power state (block 1910). As an example, this low power state request may be received from an OS, based upon a currently executing workload. More specifically in embodiments, an OS or other software entity may send a request for one or more cores to enter into a low power state. Such request may be, in certain cases, for a particular low power state, e.g., a given one of multiple C-states. Assume for purposes of discussion herein that this incoming software request is for a C6 low power state. Next it is determined whether demotion/promotion operation of the power controller is enabled (diamond 1920). For example, the power controller may reference a configuration register that indicates whether the power controller is in operation in one of a promotion or demotion mode.

If demotion/promotion operation is enabled, control passes to block 1930 where a given demoted/promoted low power state may be determined. Different considerations may come into play in determining an appropriate low power state. For example, the pipeline cost metadata and/or interrupt rate metadata may be considered, along with the requested low power state, latency information, workload information, power consumption information and so forth. In particular embodiments, the power controller may include one or more lookup tables that associate a requested low power state with a determined low power state different than the requested low power state. For example, two such tables may be provided, one for demotion operation and one for promotion operation. In such case, each entry of the given table (namely a demotion table and a promotion table) may provide an association between a requested low power state and a determined low power state, which is the low power state to be effected. Of course other manners of determining an appropriate low power state when demotion/promotion operation is enabled may occur in other embodiments.

Still with reference to FIG. 19, control passes to block 1940 where the core may be caused to enter into a particular demoted/promoted low power state. Assume that the power controller is enabled for demotion operation. In such instance, when the incoming request is for a C6 state, the power controller may cause the core to enter into a shallower state, e.g., a C1 state or another low power state of shallower duration and less performance impact than the C6 state. In contrast, where the power controller is enabled for promotion operation, when an incoming request is for a relatively shallow low power state (e.g., a C6 state), the power controller may cause the core to enter into a deeper state, e.g., a C6 state or another low power state of potentially greater duration and more performance impact than the requested state. In some cases, a comparison of costs of, e.g., C1 vs. C6 sleep states, may occur before this promotion operation.

Finally, as further shown in FIG. 19, if it is determined at diamond 1920 that demotion/promotion operation is not enabled, control instead passes to block 1950. There, the power controller may cause the core to enter into the requested low power state. As such in this instance when a software entity requests, e.g., a C6 state, the power controller causes the core to enter into the C6 state. Understand while shown at this high level in the embodiment of FIG. 19, many variations and alternatives are possible.

Embodiments thus enable use of data from the performance monitor to make better data-driven low power state decisions. In this way, embodiments enable a processor that performs better and wastes less power.

The following examples pertain to further embodiments.

In one example, a processor includes: at least one core to execute instructions, the at least one core including a cache memory hierarchy including at least one TLB and at least one core-included cache memory; a performance monitor coupled to the at least one core, the performance monitor to monitor performance of the at least one core, the performance monitor including a first counter to count misses in the at least one TLB and a second counter to count misses in the at least one core-included cache memory, the performance monitor to calculate pipeline cost metadata based at least in part on the first counter and the second counter; and a power controller coupled to the performance monitor, the power controller to receive the pipeline cost metadata and determine a low power state for the at least one core to enter based at least in part on the pipeline cost metadata.

In an example, the power controller is to receive a software request for the at least one core to enter into a second low power state and cause the at least one core to enter into a different low power state, when the pipeline cost metadata indicates that a second pipeline cost subsequent to the at least one core being in the second low power state exceeds by at least a first threshold a first pipeline cost subsequent to the at least one core being in a first low power state.

In an example, the power controller is to receive a second software request for the at least one core to enter into the first low power state and cause the at least one core to enter into the second low power state, when the pipeline cost metadata indicates that the second pipeline cost exceeds by less than a second threshold the first pipeline cost, the second low power state a deeper low power state than the first low power state.

In an example, the power controller is to enable low power state demotion operation when the pipeline cost metadata indicates that a second pipeline cost subsequent to the at least one core being in a second low power state exceeds by at least a first threshold a first pipeline cost subsequent to the at least one core being in a first low power state.

In an example, the power controller is to calculate a comparison result based on a first subset of the pipeline cost metadata associated with a first low power state and a second subset of the pipeline cost metadata associated with a second low power state.

In an example, the power controller is to enable low power state demotion operation in response to the comparison result being greater than a first threshold, the first threshold comprising a demotion threshold.

In an example, the performance monitor is to calculate interrupt rate metadata regarding a rate of incoming interrupts and communicate the interrupt rate metadata to the power controller.

In an example, the power controller is to receive a software request for the at least one core to enter into a second low power state and cause the at least one core to enter into a first low power state when the interrupt rate metadata exceeds a third threshold, the first low power state a shallower low power state than the second low power state.

In an example, the power controller is to receive a software request for a low power state of the at least one core in which the at least one TLB is to be flushed, and the at least one core to enter into a low power state in which the at least one TLB is not flushed, based at least in part on the pipeline cost metadata.

In an example, the power controller is to receive a software request for the at least one core to enter into a first low power state and cause the at least one core to enter into a different low power state based at least in part on the pipeline cost metadata associated with a plurality of cache memories of the cache memory hierarchy.

In an example, the processor further comprises a dedicated interconnect to couple the performance monitor and the power controller, the performance monitor to communicate the pipeline cost metadata to the power controller via the dedicated interconnect.

In another example, a method comprises: receiving, in a power controller of a processor, pipeline cost metadata from a performance monitor of the processor; comparing a first value of the pipeline cost metadata associated with operation of the processor subsequent to a first low power state to a second value of the pipeline cost metadata associated with operation of the processor subsequent to a second low power state; determining whether a result of the comparison exceeds a first threshold; and in response to determining that the comparison result exceeds the first threshold, enabling the power controller for demotion operation in which in response to a software request for the second low power state, the power controller causes at least one core of the processor to enter into the first low power state, the first low power state a shallower low power state than the second low power state.

In an example, the method further comprises: receiving, in the power controller, interrupt rate metadata from the performance monitor; determining whether the interrupt rate metadata exceeds a second threshold; and in response to determining that the interrupt rate metadata exceeds the second threshold, enabling the power controller for the demotion operation.

In an example, the method further comprises: in response to determining that the comparison result does not exceed the first threshold, determining whether the comparison result is less than a third threshold; and in response to determining that the comparison result is less than the third threshold, enabling the power controller for promotion operation in which in response to the software request for the second low power state, the power controller causes the at least one core of the processor to enter into the first low power state.

In an example, the method further comprises: in response to determining that the comparison result does not exceed the first threshold and exceeds the third threshold; and enabling the power controller for default operation in which in response to the software request for the second low power state, the power controller causes the at least one core to enter into the second low power state.

In an example, the method further comprises: in response to determining that the comparison result is less than the third threshold, determining whether interrupt rate metadata is less than a fourth threshold; and in response to determining that the interrupt rate metadata is less than the fourth threshold, enabling the power controller for the promotion operation.

In another example, a computer readable medium including instructions is to perform the method of any of the above examples.

In another example, a computer readable medium including data is to be used by at least one machine to fabricate at least one integrated circuit to perform the method of any one of the above examples.

In another example, an apparatus comprises means for performing the method of any one of the above examples.

In another example, a system comprises: a processor having at least one core to execute instructions, a performance monitor coupled to the at least one core, the performance monitor to monitor performance of the at least one core, the performance monitor to calculate first pipeline cost metadata associated with a first low power state and second pipeline cost metadata associated with a second low power state, and a power controller coupled to the performance monitor to receive the first pipeline cost metadata and the second pipeline cost metadata and determine whether to override a low power state request from a software entity based at least in part on the first pipeline cost metadata and the second pipeline cost metadata; and a dynamic random access memory coupled to the processor.

In an example, the power controller is to override the low power state request based on a comparison between the first pipeline cost metadata and the second pipeline cost metadata.

In an example, the performance monitor is further to calculate interrupt rate metadata regarding a rate of incoming interrupts and communicate the interrupt rate metadata to the power controller.

In an example, the power controller is to override the low power state request further based on a comparison between the interrupt rate metadata and a threshold.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor comprising:
at least one core to execute instructions, the at least one core including a cache memory hierarchy including at least one translation lookaside buffer (TLB) and at least one core-included cache memory;
a performance monitor coupled to the at least one core, the performance monitor to monitor performance of the at least one core, the performance monitor including a first counter to count misses in the at least one TLB and a second counter to count misses in the at least one core-included cache memory, the performance monitor to calculate pipeline cost metadata based at least in part on the first counter and the second counter; and
a power controller coupled to the performance monitor, the power controller to receive the pipeline cost metadata and determine a low power state for the at least one core to enter based at least in part on the pipeline cost metadata.

2. The processor of claim 1, wherein the power controller is to receive a software request for the at least one core to enter into a second low power state and cause the at least one core to enter into a different low power state, when the pipeline cost metadata indicates that a second pipeline cost subsequent to the at least one core being in the second low power state exceeds by at least a first threshold a first pipeline cost subsequent to the at least one core being in a first low power state.

3. The processor of claim 2, wherein the power controller is to receive a second software request for the at least one core to enter into the first low power state and cause the at least one core to enter into the second low power state, when the pipeline cost metadata indicates that the second pipeline cost exceeds by less than a second threshold the first pipeline cost, the second low power state a deeper low power state than the first low power state.

4. The processor of claim 1, wherein the power controller is to enable low power state demotion operation when the pipeline cost metadata indicates that a second pipeline cost subsequent to the at least one core being in a second low power state exceeds by at least a first threshold a first pipeline cost subsequent to the at least one core being in a first low power state.

5. The processor of claim 1, wherein the power controller is to calculate a comparison result based on a first subset of the pipeline cost metadata associated with a first low power state and a second subset of the pipeline cost metadata associated with a second low power state.

6. The processor of claim 5, wherein the power controller is to enable low power state demotion operation in response to the comparison result being greater than a first threshold, the first threshold comprising a demotion threshold.

7. The processor of claim 1, wherein the performance monitor is to calculate interrupt rate metadata regarding a rate of incoming interrupts and communicate the interrupt rate metadata to the power controller.

8. The processor of claim 7, wherein the power controller is to receive a software request for the at least one core to enter into a second low power state and cause the at least one core to enter into a first low power state when the interrupt rate metadata exceeds a third threshold, the first low power state a shallower low power state than the second low power state.

9. The processor of claim 1, wherein the power controller is to receive a software request for a low power state of the at least one core in which the at least one TLB is to be flushed, and the at least one core to enter into a low power state in which the at least one TLB is not flushed, based at least in part on the pipeline cost metadata.

10. The processor of claim 1, wherein the power controller is to receive a software request for the at least one core to enter into a first low power state and cause the at least one core to enter into a different low power state based at least in part on the pipeline cost metadata associated with a plurality of cache memories of the cache memory hierarchy.

11. The processor of claim 1, further comprising a dedicated interconnect to couple the performance monitor and the power controller, the performance monitor to communicate the pipeline cost metadata to the power controller via the dedicated interconnect.

12. A machine-readable medium having stored thereon instructions, which if performed by a machine cause the machine to perform a method comprising:
receiving, in a power controller of a processor, pipeline cost metadata from a performance monitor of the processor;
comparing a first value of the pipeline cost metadata associated with operation of the processor subsequent to a first low power state to a second value of the pipeline cost metadata associated with operation of the processor subsequent to a second low power state;
determining whether a result of the comparison exceeds a first threshold; and
in response to determining that the comparison result exceeds the first threshold, enabling the power controller for demotion operation in which in response to a software request for the second low power state, the power controller causes at least one core of the processor to enter into the first low power state, the first low power state a shallower low power state than the second low power state.

13. The machine-readable medium of claim 12, wherein the method further comprises:
receiving, in the power controller, interrupt rate metadata from the performance monitor;
determining whether the interrupt rate metadata exceeds a second threshold; and
in response to determining that the interrupt rate metadata exceeds the second threshold, enabling the power controller for the demotion operation.

14. The machine-readable medium of claim 12, wherein the method further comprises:
in response to determining that the comparison result does not exceed the first threshold, determining whether the comparison result is less than a third threshold; and
in response to determining that the comparison result is less than the third threshold, enabling the power controller for promotion operation in which in response to the software request for the second low power state, the power controller causes the at least one core of the processor to enter into the first low power state.

15. The machine-readable medium of claim 14, wherein the method further comprises:
in response to determining that the comparison result does not exceed the first threshold and exceeds the third threshold; and
enabling the power controller for default operation in which in response to the software request for the second low power state, the power controller causes the at least one core to enter into the second low power state.

16. The machine-readable medium of claim 14, wherein the method further comprises:
in response to determining that the comparison result is less than the third threshold, determining whether interrupt rate metadata is less than a fourth threshold; and
in response to determining that the interrupt rate metadata is less than the fourth threshold, enabling the power controller for the promotion operation.

17. A system comprising:
a processor having at least one core to execute instructions, a performance monitor coupled to the at least one core, the performance monitor to monitor performance of the at least one core, the performance monitor to calculate first pipeline cost metadata associated with a first low power state and second pipeline cost metadata associated with a second low power state, and a power controller coupled to the performance monitor to receive the first pipeline cost metadata and the second pipeline cost metadata and determine whether to override a low power state request from a software entity based at least in part on the first pipeline cost metadata and the second pipeline cost metadata; and
a dynamic random access memory coupled to the processor.

18. The system of claim 17, wherein the power controller is to override the low power state request based on a comparison between the first pipeline cost metadata and the second pipeline cost metadata.

19. The system of claim 17, wherein the performance monitor is further to calculate interrupt rate metadata regarding a rate of incoming interrupts and communicate the interrupt rate metadata to the power controller.

20. The system of claim 19, wherein the power controller is to override the low power state request further based on a comparison between the interrupt rate metadata and a threshold.
